(19) United States
(12) Patent Application Publication
(10) Pub. No.: US 2025/0184046 A1
(43) Pub. Date: Jun. 5, 2025

(54) CONFIGURING BASED ON NETWORK CODING AND MULTIPLEXING

(71) Applicant: Lenovo (Singapore) Pte. Ltd., New Tech Park (SG)

(72) Inventors: Razvan-Andrei Stoica, Witten (DE); Hossein Bagheri, Dearborn Heights, MI (US); Vijay Nangia, Woodridge, IL (US)

(21) Appl. No.: 18/844,760

(22) PCT Filed: Mar. 7, 2023
(86) PCT No.: PCT/IB2023/052165

§ 371 Date: Sep. 6, 2024

Related U.S. Application Data
(60) Provisional application No. 63/317,235, filed on Mar. 7, 2022.

(51) Int. Cl. H04L 1/1829; H04L 27/26; H04W 72/232

(52) U.S. Cl. CPC H04L 1/1864; H04L 27/2607; H04W 72/232

(57) ABSTRACT

Apparatuses, methods, and systems are disclosed for configuring based on network coding (“NC”) and multiplexing. One method includes receiving a multiplexing configuration of at least one network-coded logical channel and at least one non-network-coded logical channel multiplexed for transmissions scheduled over at least one transport block (“TB”). The method includes receiving a NC configuration corresponding to each network-coded logical channel of the at least one network-coded logical channel corresponding to each TB of the at least one TB. The method includes determining, for each network-coded logical channel of the at least one network-coded logical channel corresponding to each TB of the at least one TB, a code block (“CB”) threshold based at least on the NC configuration and the multiplexing configuration.

### FIELD

The subject matter disclosed herein relates generally to wireless communications and more particularly relates to configuring based on network coding (“NC”) and multiplexing.

### BACKGROUND

In certain wireless communications networks, extended reality (“XR”) may be used. In such networks, communications may not be efficient.

### BRIEF SUMMARY

Methods for configuring based on NC and multiplexing are disclosed. Apparatuses and systems also perform the functions of the methods. One embodiment of a method includes receiving, at a receiving device, a multiplexing configuration of at least one network-coded logical channel and at least one non-network-coded logical channel multiplexed for transmissions scheduled over at least one transport block (“TB”). In some embodiments, the method includes receiving a NC configuration corresponding to each network-coded logical channel of the at least one network-coded logical channel corresponding to each TB of the at least one TB. In certain embodiments, the method includes determining, for each network-coded logical channel of the at least one network-coded logical channel corresponding to each TB of the at least one TB, a code block (“CB”) threshold based at least on the NC configuration and the multiplexing configuration. In some embodiments, the method includes configuring, for each TB of the at least one TB, a NC-aware and multiplexing-aware hybrid automatic repeat request (“HARQ”) process with the CB threshold and the multiplexing configuration. In certain embodiments, the method includes using the CB threshold and the multiplexing configuration to determine a NC-aware and multiplexing aware HARQ feedback report for each TB of the at least one TB.

One apparatus for configuring based on NC and multiplexing includes a receiving device. In some embodiments, the apparatus includes a receiver that: receives a multiplexing configuration of at least one network-coded logical channel and at least one non-network-coded logical channel multiplexed for transmissions scheduled over at least one TB; and receives a NC configuration corresponding to each network-coded logical channel of the at least one network-coded logical channel corresponding to each TB of the at least one TB. In various embodiments, the apparatus includes a processor that: determines, for each network-coded logical channel of the at least one network-coded logical channel corresponding to each TB of the at least one TB, a CB threshold based at least on the NC configuration and the multiplexing configuration; configures, for each TB of the at least one TB, a NC-aware and multiplexing-aware HARQ process with the CB threshold and the multiplexing configuration; and uses the CB threshold and the multiplexing configuration to determine a NC-aware and multiplexing aware HARQ feedback report for each TB of the at least one TB.

Another embodiment of a method for configuring based on NC and multiplexing includes determining, at a network device, a multiplexing configuration of at least one network-coded logical channel and at least one non-network-coded logical channel multiplexed for transmissions scheduled over at least one TB. In some embodiments, the method includes determining a NC configuration corresponding to each network-coded logical channel of the at least one network-coded logical channel corresponding to each TB of the at least one TB. In certain embodiments, the method includes determining, for each network-coded logical channel of the at least one network-coded logical channel corresponding to each TB of the at least one TB, a CB threshold based at least on the NC configuration and the multiplexing configuration. In various embodiments, the method includes transmitting the multiplexing configuration, the NC configuration, the CB threshold, or some combination thereof to a receiver device for NC-aware and multiplexing-aware HARQ feedback for each TB of the at least one TB. In some embodiments, the method includes receiving the NC-aware and multiplexing-aware HARQ feedback from the receiver device for each TB of the at least one TB. In certain embodiments, the method includes applying the NC-aware and multiplexing-aware HARQ feedback to determine necessary TB retransmissions.

Another apparatus for configuring based on NC and multiplexing includes a network device. In some embodiments, the apparatus includes a processor that: determines a multiplexing configuration of at least one network-coded logical channel and at least one non-network-coded logical channel multiplexed for transmissions scheduled over at least one TB; determines a NC configuration corresponding to each network-coded logical channel of the at least one network-coded logical channel corresponding to each TB of the at least one TB; and determines, for each network-coded logical channel of the at least one network-coded logical channel corresponding to each TB of the at least one TB, a CB threshold based at least on the NC configuration and the multiplexing configuration. In various embodiments, the apparatus includes a transmitter that transmits the multiplexing configuration, the NC configuration, the CB threshold, or some combination thereof to a receiver device for NC-aware and multiplexing-aware HARQ feedback for each TB of the at least one TB. In certain embodiments, the apparatus includes a receiver that receives the NC-aware and multiplexing-aware HARQ feedback from the receiver device for each TB of the at least one TB. In some embodiments, the processor applies the NC-aware and multiplexing-aware HARQ feedback to determine necessary TB retransmissions.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for configuring based on NC and multiplexing;

FIG. 2 is a schematic block diagram illustrating one embodiment of an apparatus that may be used for configuring based on NC and multiplexing;

FIG. 3 is a schematic block diagram illustrating one embodiment of an apparatus that may be used for configuring based on NC and multiplexing;

FIG. 4 is a schematic block diagram illustrating one embodiment of a split-rendering architecture system;

FIG. 5 is a schematic block diagram illustrating one embodiment of a communication system architecture;

FIG. 6 is a schematic block diagram illustrating one embodiment of integration of timing of NC at a radio link control (“RLC”) layer;

FIG. 7 is a schematic block diagram illustrating one embodiment of timing of a XR application downlink (“DL”)/uplink (“UL”) traffic model;

FIG. 8 is a schematic block diagram illustrating one embodiment of medium access control (“MAC”) multiplexing of a network-coded logical channel with another logical channel;

FIG. 9 is a schematic block diagram illustrating one embodiment of DL multiplexing of a network-coded logical channel with MAC control elements (“CE”) (“MAC-CE”) elements;

FIG. 10 is a schematic block diagram illustrating one embodiment of DL MAC multiplexing of a network-coded logical channel with MAC-CE elements and with another logical channel;

FIG. 11 is a schematic block diagram illustrating one embodiment of TB multiplexing 2 16 bits MAC-CEs, 1 network-coded logical channel, and 1 non-network-coded logical channel;

FIG. 12 is a schematic block diagram illustrating one embodiment of network-coded transmissions with HARQ acknowledgment (“HARQ-ACK”) feedback upon receiving a TB with some erroneous CBs less than a determined threshold based on the NC redundancy level;

FIG. 13 is a schematic block diagram illustrating one embodiment of network-coded transmissions with HARQ-NACK feedback upon receiving a TB with some erroneous CBs more than a determined threshold based on the NC redundancy level;

FIG. 14 is a schematic block diagram illustrating one embodiment of network-coded transmissions with HARQ-NACK feedback upon receiving a TB with one erroneous CB containing some non-network-coded logical channel data;

FIG. 15 is a schematic block diagram illustrating one embodiment of timing of consecutive and non-consecutive CB errors and a mapping to network-coded packets;

FIG. 16 is a schematic block diagram illustrating one embodiment of code block group (“CBG”)-based retransmission with NC-aware and multiplexing-aware HARQ process monitoring procedure (e.g., initial transmission);

FIG. 17 is a schematic block diagram illustrating one embodiment of CBG-based retransmission with NC-aware and multiplexing-aware HARQ process monitoring procedure (e.g., upon CBG #1 retransmission);

FIG. 18 is a schematic block diagram illustrating one embodiment of CBG-based retransmission with NC-aware and multiplexing-aware HARQ process monitoring procedure for a NACKed CBG due to a CB error whereby non-network-coded logic channel data or control elements are multiplexed;

FIG. 19 is a flow chart diagram illustrating one embodiment of a method for configuring based on NC and multiplexing; and

FIG. 20 is a flow chart diagram illustrating another embodiment of a method for configuring based on NC and multiplexing.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

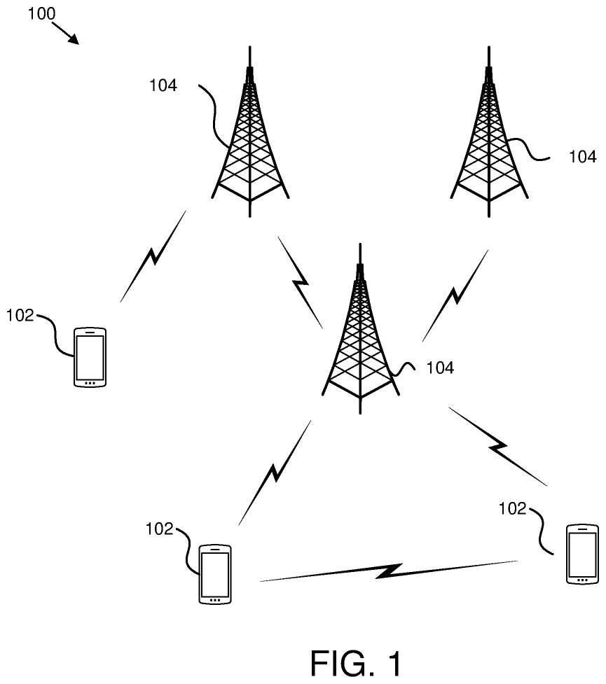

FIG. 1 depicts an embodiment of a wireless communication system 100 for configuring based on NC and multiplexing. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, user equipment (“UE”), user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-third generation partnership project (“3GPP”) gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in 3GPP, wherein the network unit 104 transmits using an orthogonal frequency division multiplexing (“OFDM”) modulation scheme on the DL and the remote units 102 transmit on the UL using a single-carrier frequency division multiple access (“SC-FDMA”) scheme or an OFDM scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may determine, at a receiving device, a NC configuration for transmission of a scheduled network-coded application data unit (ADU). In some embodiments, the remote unit 102 may receive, at a receiving device, a multiplexing configuration of at least one network-coded logical channel and at least one non-network-coded logical channel multiplexed for transmissions scheduled over at least one TB. In some embodiments, the remote unit 102 may receive a NC configuration corresponding to each network-coded logical channel of the at least one network-coded logical channel corresponding to each TB of the at least one TB. In certain embodiments, the remote unit 102 may determine, for each network-coded logical channel of the at least one network-coded logical channel corresponding to each TB of the at least one TB, a CB threshold based at least on the NC configuration and the multiplexing configuration. In some embodiments, the remote unit 102 may configure, for each TB of the at least one TB, a NC-aware and multiplexing-aware HARQ process with the CB threshold and the multiplexing configuration. In certain embodiments, the remote unit 102 may use the CB threshold and the multiplexing configuration to determine a NC-aware and multiplexing aware HARQ feedback report for each TB of the at least one TB. Accordingly, the remote unit 102 may be used for configuring based on NC and multiplexing.

In certain embodiments, a network unit 104 may determine, at a network device, a multiplexing configuration of at least one network-coded logical channel and at least one non-network-coded logical channel multiplexed for transmissions scheduled over at least one TB. In some embodiments, the network unit 104 may determine a NC configuration corresponding to each network-coded logical channel of the at least one network-coded logical channel corresponding to each TB of the at least one TB. In certain embodiments, the network unit 104 may determine, for each network-coded logical channel of the at least one network-coded logical channel corresponding to each TB of the at least one TB, a CB threshold based at least on the NC configuration and the multiplexing configuration. In various embodiments, the network unit 104 may transmit the multiplexing configuration, the NC configuration, the CB threshold, or some combination thereof to a receiver device for NC-aware and multiplexing-aware HARQ feedback for each TB of the at least one TB. In some embodiments, the network unit 104 may receive the NC-aware and multiplexing-aware HARQ feedback from the receiver device for each TB of the at least one TB. In certain embodiments, the network unit 104 may apply the NC-aware and multiplexing-aware HARQ feedback to determine necessary TB retransmissions. Accordingly, the network unit 104 may be used for configuring based on NC and multiplexing.

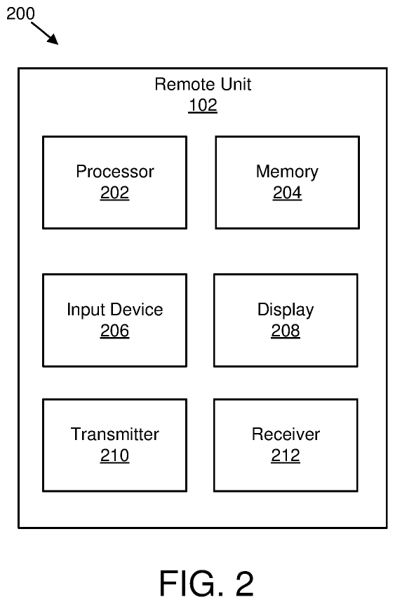

FIG. 2 depicts one embodiment of an apparatus 200 that may be used for configuring based on NC and multiplexing. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the receiver 212: receives a multiplexing configuration of at least one network-coded logical channel and at least one non-network-coded logical channel multiplexed for transmissions scheduled over at least one TB; and receives a NC configuration corresponding to each network-coded logical channel of the at least one network-coded logical channel corresponding to each TB of the at least one TB. In various embodiments, the processor 202: determines, for each network-coded logical channel of the at least one network-coded logical channel corresponding to each TB of the at least one TB, a CB threshold based at least on the NC configuration and the multiplexing configuration; configures, for each TB of the at least one TB, a NC-aware and multiplexing-aware HARQ process with the CB threshold and the multiplexing configuration; and uses the CB threshold and the multiplexing configuration to determine a NC-aware and multiplexing aware HARQ feedback report for each TB of the at least one TB.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

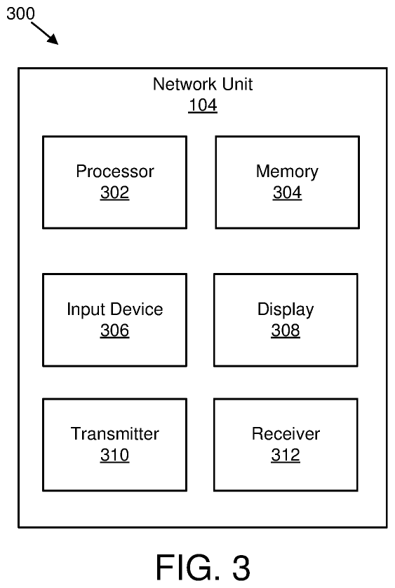

FIG. 3 depicts one embodiment of an apparatus 300 that may be used for configuring based on NC and multiplexing. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the processor 302: determines a multiplexing configuration of at least one network-coded logical channel and at least one non-network-coded logical channel multiplexed for transmissions scheduled over at least one TB; determines a NC configuration corresponding to each network-coded logical channel of the at least one network-coded logical channel corresponding to each TB of the at least one TB; and determines, for each network-coded logical channel of the at least one network-coded logical channel corresponding to each TB of the at least one TB, a CB threshold based at least on the NC configuration and the multiplexing configuration. In various embodiments, the transmitter 310 transmits the multiplexing configuration, the NC configuration, the CB threshold, or some combination thereof to a receiver device for NC-aware and multiplexing-aware HARQ feedback for each TB of the at least one TB. In certain embodiments, the receiver 312 receives the NC-aware and multiplexing-aware HARQ feedback from the receiver device for each TB of the at least one TB. In some embodiments, the processor 302 applies the NC-aware and multiplexing-aware HARQ feedback to determine necessary TB retransmissions.

It should be noted that one or more embodiments found herein may be combined together. In certain embodiments, there may be a service-oriented design considering extended reality (“XR”) traffic characteristics (e.g., (a) variable packet arrival rate: packets coming at 30-120 frames/second with some jitter, (b) packets having variable and large packet size, (c) B/P-frames being dependent on I-frames, (d) presence of multiple traffic/data flows such as pose and video scene in uplink, (e) various degrees of importance between I/P/B-frames in contributing to the end-to-end quality of user experience) to enable more efficient (e.g., in terms of satisfying XR service requirements for a greater number of user equipments (“UEs”), in terms of UE power saving, or in terms of XR traffic reliability and rendering robustness against wireless networks transmissions effects) XR service delivery.

In some embodiments, there may be NC, or fountain codes (e.g., whereby a code can generate an unbounded number of repair symbols as redundancies to counteract potential erasures due to transmission channel losses) at a packet level considered within radio access networks for reducing a latency of XR traffic by means of reduced or eliminated retransmissions feedback (e.g., hybrid automatic repeat request (“HARQ”), automatic repeat request (“ARQ”)), while also increasing the reliability of the XR associated traffic.

In various embodiments, for XR traffic combining low-latency, quasi-periodic, high-throughput data bursts, NC procedures may be used to maintain simultaneously a high spectral efficiency and low latency, by optimizing a required level of redundancy needed to avoid an unnecessary high quota of repair packets or retransmissions. To this extent, efficient feedback reporting of the NC-aware acknowledgement state for the received information is essential to provide to a transmitter the necessary statistics related to the channel conditions for adaptation of the NC, channel coding, and modulation configurations of subsequent transmissions.

In certain embodiments, there may be mechanisms for NC-aware acknowledgement feedback of network-coded radio access network transmissions with multiplexing as enhanced HARQ feedback meant to provide necessary link information to the network to effectively adapt its coding and transmission characteristics. Concretely, a NC-aware and multiplexing-aware HARQ feedback procedure and associated signaling mechanisms are used.

In some embodiments, XR is an umbrella term for different types of realities including: 1) virtual reality (“VR”) which is a rendered version of a delivered visual and audio scene—the rendering is designed to mimic the visual and audio sensory stimuli of the real world as naturally as possible to an observer or user as they move within the limits defined by the application—virtual reality usually, but not necessarily, requires a user to wear a head mounted display (“HMD”) to completely replace the user's field of view with a simulated visual component, and to wear headphones, to provide the user with the accompanying audio—some form of head and motion tracking of the user in VR is usually also necessary to allow the simulated visual and audio components to be updated to ensure that, from the user's perspective, items and sound sources remain consistent with the user's movements—additional means to interact with the virtual reality simulation may be provided but are not strictly necessary; 2) augmented reality (“AR”) which is when a user is provided with additional information or artificially generated items, or content overlaid upon their current environment—such additional information or content will usually be visual and/or audible and their observation of their current environment may be direct, with no intermediate sensing, processing, and rendering, or indirect, where their perception of their environment is relayed via sensors and may be enhanced or processed; and/or 3) mixed reality (“MR”) which is an advanced form of AR where some virtual elements are inserted into the physical scene with the intent to provide the illusion that these elements are part of the real scene.

In various embodiments, XR refers to all real-and-virtual combined environments and human-machine interactions generated by computer technology and wearables. It includes representative forms such as AR, MR, and VR and the areas interpolated among them. The levels of virtuality range from partially sensory inputs to fully immersive VR. A key aspect of XR is the extension of human experiences especially relating to the senses of existence (e.g., represented by VR) and the acquisition of cognition (e.g., represented by AR).

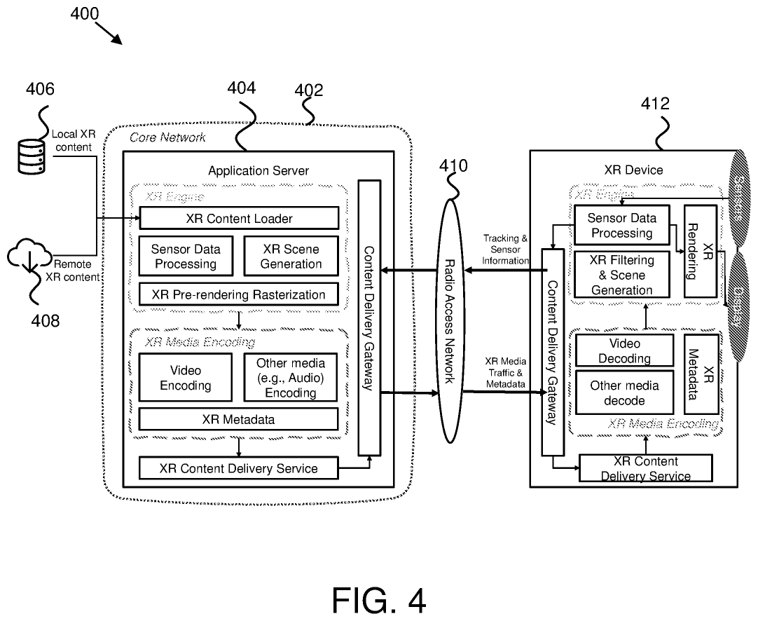

In certain embodiments, a common setup adopted at a 3GPP level for immersive XR and high-performance video content transmissions relies on a concept of split rendering. This uses an application server located at an edge and connected to a core network (“CN”) which is used to encode the application video content and transfer it to a radio access network (“RAN”) for mobile communications. In exchange, the RAN communicates with a connected UE which may use additional hardware and/or software processing to render the video content to match a user's pose, inputs, and/or control state. This architectural approach is displayed for reference in FIG. 4.

FIG. 4 is a schematic block diagram illustrating one embodiment of a split-rendering architecture system 400. The system 400 includes a CN 402 that includes an application server 404 that communicates local XR content 406 and remote XR content 408. The CN 402 communicates with a RAN 410. Further, the system 400 includes an XR device 412 (e.g., UE device) that communicates with the RAN 410. The split-rendering architecture for mobile networks is based on an edge and/or cloud video application server (e.g., application server 404) and the XR device 412. The application server 404 may deliver XR media based on local XR processed content or on remote XR processed content. The processing may account for and/or further process tracking and sensing information as uplinked by the XR device 412. The application server 404 streams the XR multimedia content via a content delivery gateway to which the XR device 412 is connected via any real-time transport protocol. The XR device 412, after decoding the XR content received from the application server 404, may use its XR engine and additional local hardware and/or software capabilities and/or XR pre-rendered content, and XR associated XR metadata to locally render the XR content on a display.

The video application server 404 is used therefore to process, encode, and/or transcode and serve local or remote video content pertaining to an XR and/or cloud gaming (“CGM”) application session to the XR device 412. The video application server 404 may as a result encode and/or transcode and control the video viewport content and transmit it in downlink to the RAN based on UE specific parameters, configurations and sensing inputs that may affect the rendering perspective, rate, quality, panning, and so forth. This architecture may be expected to leverage the advantages of various compute and network domains (e.g., cloud, edge, smart handsets and/or headsets) to enable scalable XR and/or CGM applications and use cases with low-latency, high rate, and efficient energy usage. The architecture may be universally applicable both to split rendering with asynchronous time warping devices (e.g., where the video application server 404 encodes a rasterized pre-processed viewport representation to aid the UE), or to split rendering with viewport rendering at the device side (e.g., where the video viewport may be completely or partially rendered at the device side given the media encoded video content and its corresponding metadata available).

In certain embodiments, XR traffic in DL is generically characterized by a quasi-periodic, jitter-affected packet arrival rate determined by the XR application frame generation rate periodicity (e.g., 30, 60, 90, and/or 120 fps). As such, the average packet arrival periodicity is obtained as the reciprocal of the application frame rate (e.g., 16.67 ms=1/60 fps). Thus, the periodic arrival time without jitter at gNB of XR packets indexed by k=1, 2, 3, . . . is shown in Equation 1, where F denotes the XR application video frame generation rate (e.g., per second).

$${τ}_{k} = \frac{k}{F} \cdot 1000 [ ms ] , \qquad Equation 1$$

This periodic packet arrival model of Equation 1 implicitly assumes fixed a delay contributed from a network side including fixed video encoding time, fixed network transfer delay, and so forth.

However, in some embodiments in a real system, a varying frame encoding delay and network transfer time introduces stochastic jitter in packet arrival time at gNB. Generically, the jitter is modelled as a truncated Gaussian random process resulting into a random variable added on top of periodic arrivals. The jitter contribution to the packet arrival time thus generates an additive truncated Gaussian distribution to the inherent ideal periodicity of the XR DL traffic with statistical parameters as in Table 1.

TABLE 1
Statistical parameters for jitter of downlink XR traffic

| | Unit of | Baseline model | Optional model |
|---|---|---|---|
| Parameter | measure | value for evaluation | value for evaluation |
| Mean | ms | 0 | |
| Standard deviation | ms | 2 | |
| Truncation range | ms | [−4, 4] | [−5, 5] |

In various embodiments, given the jitter model of Table 1 considered in 3GPP for fifth generation (“5G”) and beyond AN, even for high frame generation rates (e.g., 120 fps), the combined realistic XR DL traffic model ensures in-order packet arrivals (e.g., arrival time of a next packet is always larger than that of the previous packet). Concretely, the XR DL traffic model of periodic arrival with jitter for an arrival time of a video frame packet with index k=1,2,3, . . . is summarized by Equation 2, where F is the given frame generation rates (per second) and J is the jitter specific random variable following the model of Table 2, and respectively, the offset represents an arbitrary UE specific shift in packet arrival timing.

$${τ}_{k} = offset + \frac{k}{F} \cdot 1000 + J [ ms ] , \qquad Equation 2$$

In certain embodiments, in the UL direction, the XR and/or CGM traffic is similarly generically characterized by user inputs, control metadata, pose updates, panning information, and the like, and the latter is modelled by an UL pose and/or control stream traffic model where packets arrive at the UE periodically with parameters tabulated as in Table 2.

TABLE 2
Statistical parameters for the UL XR,
CGM pose, and/or control traffic model

| | | Baseline values for |
|---|---|---|
| Parameters | unit | evaluation |
| Periodicity | ms | 4 |
| Jitter | ms | No jitter |
| Packet size | byte | 100 |
| PDB | ms | 10 |

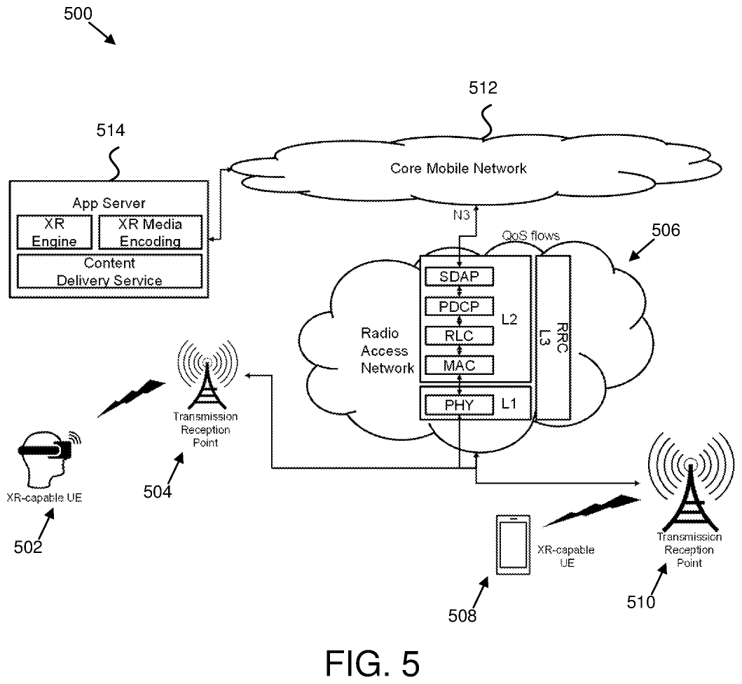

FIG. 5 is a schematic block diagram illustrating one embodiment of a communication system 500 architecture. The communication system 500 includes a first XR-capable UE 502, a first transmission reception point (“TRP”) 504, a RAN 506, a second XR-capable UE 508, a second TRP 510, a core mobile network 512, and an application (“app”) server 514. FIG. 5 includes the source application server 514 connected (e.g., possibly at the edge) to the core mobile network 512 which is connected to the RAN 506 serving subscribed and connected user equipment. As illustrated in FIG. 5Error! Reference source not found., the protocol data units (“PDUs”) associated with an XR application session of an application server connected to a core network (“CN”) is transferred via the CN user plane function (“UPF”) over the internet protocol (“IP”) to the mobile RAN. The multimedia traffic may be further supported by a real-time multimedia transport protocol such as a real-time transport protocol (“RTP”) or alike to handle jitter, packet loss, and out-of-order deliveries that may occur within a typical IP network setup.

The quality of service (“QoS”) associated with IP packets of the XR traffic is handled by the CN via QoS flows generated at the UPF within the established PDU session. This procedure is opaque to the RAN 506 which only manages the mapping of QoS flows associated with the received IP packets to their corresponding DRBs given the QoS profile associated with the indicators of each QoS flow. In a 5G system (“5GS”), for instance, the QoS flows will be characterized by the 5G QoS identifier (“5QI”). This latter mapping of QoS flows to data radio bearers (“DRBs”) is performed within the RAN by the service data adaptation protocol (“SDAP”) layer. The SDAP PDU is then processed by the packet data convergence protocol where among others header compression and ciphering are performed and the outputs further processed by the RLC. The RLC may perform segmentation of the packet data convergence protocol (“PDCP”) PDUs and implements the automatic request response (“ARQ”) repetition retransmissions. The RLC PDUs are then processed over the logical channels interfaces by the MAC layer which handles the logical channels multiplexing, HARQ, scheduling, and scheduling retransmission functions. Lastly, the MAC PDUs are combined over the transport channel into TBs at the level of physical (“PHY”) layer. The PHY handles the coding and/or decoding, rate matching, modulation and/or demodulation, radio resource mapping, multiantenna mapping, and other typical radio low-level functions.

The PHY TBs, which are appended with their own cyclic redundancy check (“CRC”) of 16 or 24 bits blocks for detection of errors, are further partitioned into same-sized coding blocks (“CBs”). The CBs are appended as well by 24 bits CRC for error detection and following this operation they are forward error correction (“FEC”) encoded by the PHY. The HARQ procedure within 5G NR ensures incremental redundancy retransmissions of an entire TB if any of the CBs or TB CRC checks fails thus effectively ensuring reliability over the wireless link. In addition, given the increasing size of TBs, 5G NR also introduced a CBG construct to group one or more CBs into CBGs. The CBGs, if configured appropriately via radio resource control (“RRC”), support independent HARQ via downlink control information (“DCI”) signaling primarily via CBG transmit indicator (“CBGTI”) and CBG flush indicator (“CBGFI”) within the same HARQ process as the enclosing TB. As such, some mechanisms for versatile retransmissions are present in fifth generation (“5G”) new radio (“NR”) to reduce retransmissions delays and resource utilization, applicable also to high-rate low-latency traffic such as immersive XR and/or CGM media applications. Yet these procedures are purely based on traditional FEC mechanisms, applied at a bit-level unaware of XR application data units (“ADUs”) (e.g., the smallest unit of data that can be processed independently by an application, e.g., a video frame, a slice of a video frame, and so forth) and XR traffic characteristics.

In certain embodiment, NC is a general procedure to provide packet-based redundancy for increasing the reliability of communications systems over packet-switched networks. NC provides by means of linear combinations over (e.g., finite) Galois fields, or alternatively, by random XORing operations repair packets (e.g., or symbols) which act as redundancy packets meant to provide to a receiver the redundant information to potentially recover originally transmitted data.

In some embodiments, concretely, given a set of K information packets (e.g., or symbols) {S₁, S₂, . . . , S_{K}} of the same size, a linear network-coded packet is obtained by the combination Rⱼ=Σᵢ₌₁^{K}gᵢⱼ·Sᵢ, whereby the encoding coefficients vector gⱼ=[g₁ⱼ, g₂ⱼ, . . . , g_{Kj}]^{T} is formed by values from a Galois field [symbol] , e.g. [symbol] ₂, [symbol] ₈, [symbol] ₂₅₆, and so forth. By optimization and selection of a proper distribution of the vectors g∈ [symbol] ^{K}, an infinite number of redundant network coded packets may be thus coded. Considering a fix number N of packets to be generated by a generator coefficient matrix G=[g₁, g₂, . . . , g_{N}]∈ [symbol] , selected such that any K columns of G are linearly independent, whereby the latter condition is exactly fulfilled if G is the generator matrix of a maximum distance separable (“MDS”) code, e.g., Reed-Solomon code, or is asymptotically fulfilled if G is randomly generated over a sufficiently large field size. Probabilistic constructions of the latter randomization strategy for determining G may minimize the field size and increase encoding efficiency of asymptotic and numeric constructions by means of optimization of the degree distribution of each encoded repair packet (or symbol), e.g., as for Luby transform (“LT”) and derivatives Raptor, and RaptorQ codes thereof.

In various embodiments, given an ideal linear network code, whereby any K columns of G are linearly independent such any K×K reduced matrix G′ is full rank, the original K packets (or symbols) can be recovered by Gaussian elimination or inverse encoding operation (or XORing) with G′⁻¹. As a consequence, the original K packets (or symbols) can be recovered from any K′≥K received packets (or symbols), whether they are systematic information packets (or symbols) or repair packets (or symbols), respectively.

In certain embodiments, network codes make them applicable as error correction mechanisms against packet (or symbols) erasures, benefitting with transmit and path diversity. To this end, they have been successfully used at the network level as error correction mechanism aiding the transmission control protocol (“TCP”) congestion control mechanism for reducing retransmissions needs, inherent latency, and alleviating congestion effects of reliable transmission protocols over the IP based systems.

In some embodiments, NC may be used for multicast broadcast transmissions as an application level FEC for file delivery over unidirectional transport (e.g., in downlink for content download), and for multi-hop communications at the 5G RAN level in the context of integrated access and backhaul (“TAB”) deployments. Furthermore, NC may be used as an enabler to outer coding immersive and/or interactive XR and/or CGM applications with high-rate and low-latency requirements given the increased packet-wise reliability and potential latency reduction (e.g., by avoiding higher layer retransmissions).

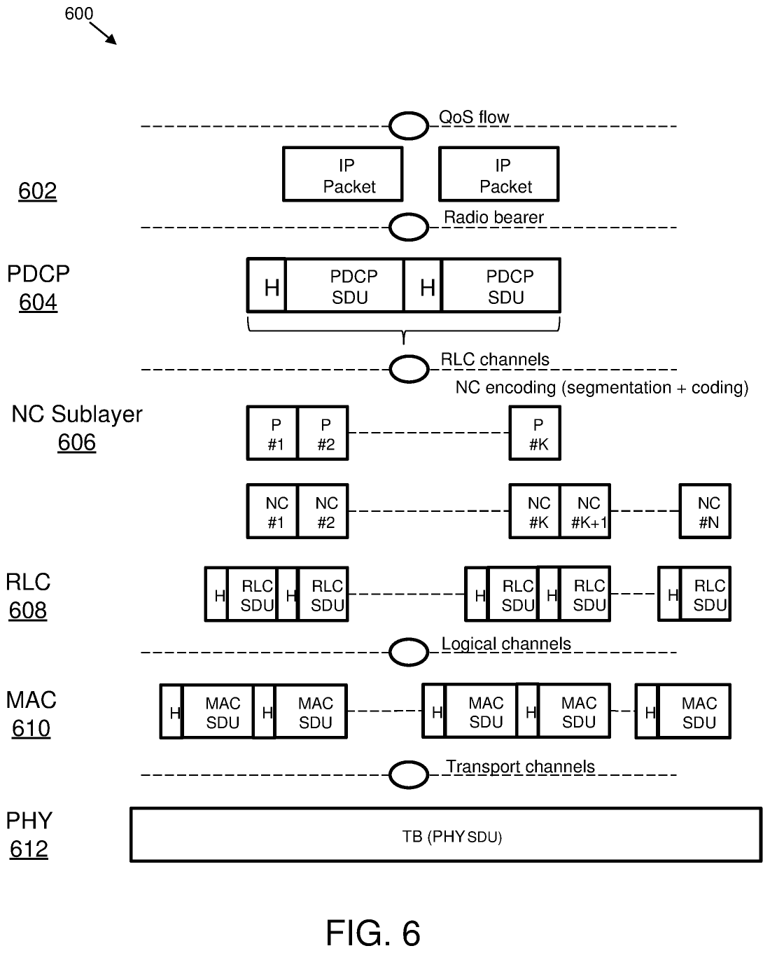

In various embodiments, NC may be used as outer coding for the XR DL unicast transmission link between the next generation node B (“gNB”) and a UE, whereby the network code applied at the RLC layer (e.g., on the PDCP PDU) spanning over an ADU, as shown in FIG. 6.

FIG. 6 is a schematic block diagram illustrating one embodiment of timing 600 of integration of NC at an RLC layer. The timing 600 shows SDAP 602, PDCP 604, NC sublayer 606, RLC 608, MAC 610, and PHY 612. Application of random linear NC at the level of the long term evolution (“LTE”) and 5G RAN stacks respectively and studied various architectural possibilities, with similar proposals either at the RLC layer or at the PDCP layer. It should be noted that none of the previous works performed an explicit analysis of HARQ and/or ARQ required modifications for NC PDU sessions over the RAN utilizing prior art HARQ and/or ARQ retransmissions mechanisms, either as in no feedback mode or in full feedback mode as detailed next.

In certain embodiments, retransmissions are inherently embedded into a protocol stack of LTE and/or 5G RAN for reliability purposes over wireless channels. Three levels of protection may be available across the stack at different layers with varying characteristics of reliability, latency, and overall role, as follows at: 1) PDCP layer: a) PDCP retransmissions are used for acknowledged mode (“AM”) configurations in case of handovers or whenever necessary to ensure in-order delivery of PDUs based on configured PDCP status reports, b) PDCP duplication is the main redundancy mechanism at this layer relying on simple repetition coding, c) PDCP retransmissions delays may vary between 50-150 ms depending on the data radio bearer air interface configuration, including subcarrier spacing (“SCS”) and modulation and coding scheme (“MCS”); 2) RLC layer: a) RLC retransmissions are used only for AM configurations to ensure reliable delivery of RLC PDUs, b) RLC relies on automatic repeat request (“ARQ”) (e.g., simple repetition-based retransmissions) as redundancy mechanism upon receival of status reports from the peer receiving protocol, c) RLC retransmission delays may vary between 10-50 ms based on the infrequent status reports feedback and air interface configuration, including SCS and MCS; and 3) PHY layers: a) PHY retransmissions rely on hybrid ARQ (e.g., HARQ) mechanism with soft combining embedding FEC channel coding with ARQ retransmissions for a highly robust and adaptive retransmission scheme ensuring high reliability, b) PHY retransmissions are controlled by individual HARQ processes within a HARQ entity as part of the MAC and are scheduled accordingly by the latter given the HARQ feedback of a receiver indication non-acknowledgement (e.g., NACK) (or equivalently HARQ-NACK), c) PHY retransmission delays may vary between 2-10 ms based on the scheduling, SCS and MCS configurations.

In some embodiments, placing network and/or outer coding sub-layer between PDCP and RLC layers allows one to: 1) take advantage of segmentation function of the RLC layer; 2) adapt network and/or outer coding parameters, such as the redundancy level, based on channel conditions; and/or 3) apply network/outer coding on specific radio bearers.

In various embodiments, at a network and/or outer coding sub-layer, k sub-packets are encoded into n=k*(1+y %) for y % of redundancy. These coded packets are subsequently processed by RLC, MAC, and PHY layers. XR traffic characteristics include relatively high data rate, stringent latency bound, and reliability requirements. Given these requirements, the addition of NC as outer coding (“OC”) in the RAN protocol stack together with exploiting link diversity provide performance benefits over other existing NR schemes, such as baseline HARQ and PDCP duplication. Redundancy added upfront for NC could help XR traffic to fulfil latency and reliability requirements without having to resort to HARQ and/or RLC retransmissions that would increase the delay of packet reception, especially in cases of blocking. Compared to the PDCP duplication, NC can offer adaptive redundancy, which allows for more efficient operation by adapting to the current traffic load and reliability and/or latency requirements. Constant redundancy of PDCP duplication may result in excessive system load, stalling the traffic and reducing capacity. FIG. 6 illustrates this architecture of the NC sublayer 606.

In certain embodiments: 1) for XR and cloud gaming traffic, the network and/or outer coding with HARQ disabled can result in both latency and power benefits compared to the HARQ enabled case with no added redundancy; 2) for XR and cloud gaming traffic in frequency range 2 (“FR2”) without carrier aggregation, the network and/or outer coding with HARQ disabled can result in both latency and power benefits compared to the HARQ enabled case with no added redundancy in certain cases; and/or 3) for XR and cloud gaming traffic in FR2 with carrier aggregation, the NC with HARQ disabled can result in both latency and power benefits compared to the HARQ enabled case with no added redundancy in all cases.

In some embodiments, a behavior of NC without HARQ feedback versus baseline 5G HARQ non-NC transmissions could be implemented under fixed MCS assumptions, and different NC redundancy levels. As such, no dynamic outer loop control for the joint NC redundancy level and MCS configuration can be considered or explicitly described, which will negatively impact the potential of higher spectral efficiency for NC-based transmissions. In fact, NC has greater potential of spectral efficiency by means of adaptive redundancy configuration and MCS selection which considers both the link signal-to-interference-noise ratio (“SINR”) as well as the link-diversity (e.g., spatial layers, time resources, propagation paths (e.g., dual connectivity, multi-hop relaying, carrier aggregation, etc.)). Since this dynamic adaptation is not possible without explicit feedback, HARQ disablement may require additional signaling to acquire necessary channel quality indicator (“CQI”), channel state information (“CSI”), or similar information to aid for adaptation of NC redundancy and MCS to link SINR conditions.

In various embodiments, there may be HARQ feedback and retransmissions configuration, and procedures associated with NC in support of adaptation of redundancy levels and MCS.

In certain embodiments, low-latency HARQ based mechanisms for increasing reliability, spectral efficiency of high-rate, low-latency, and quasi-periodic data traffic specific for instance to immersive media applications such as XR and CGM may be provided. To this end, NC outer coding redundancy, HARQ procedures, and various optimization thereof may be used for eliminating and/or reducing latency of necessary retransmissions and feedback reporting in heterogeneous scenarios where MAC multiplexing of logical channels is enabled and active.

In some embodiments, given the XR and/or CGM DL and UL traffic periodicity, embodiments and examples in the sequel assume a basic scenario where XR video coded frames and associated codec metadata are mainly transported over the air interface over the physical downlink shared channel (“PDSCH”) in DL at a periodicity of

$$\frac{1}{fps}$$

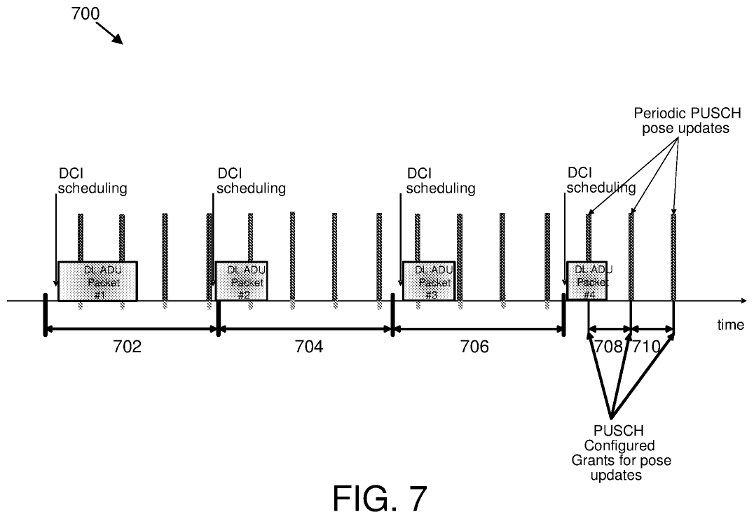

with the stochastic jitter model previously described, whereas in UL the user pose, inputs and associated application metadata are transported over the physical uplink shared channel (“PUSCH”). As an example, consider video codec frame rate at 60 fps (e.g., corresponding to PDSCH periodicity of 16.67 ms), whereas the UL pose update is considered at 4 ms as outlined in FIG. 7.

FIG. 7 is a schematic block diagram illustrating one embodiment of timing 700 of a XR application DL/UL traffic model. The timing 700 illustrates a periodicity

$$\frac{1}{fps}$$

702, 704, and 706 (e.g., 16.67 ms). Further, the timing 700 includes a periodicity 708 and 710 between periodic PUSCH pose updates (e.g., 4 ms). In various embodiments, the NC architecture outlined in FIG. 6 is enabled for DL whereby MAC level multiplexing of other logical channels (e.g., network-coded or non-network-coded) or MAC-CE is enabled and active. The NC scheme is thus applied at XR and/or CGM ADU level (e.g., for each ADU burst of PDCP PDUs), and a HARQ baselines consist of either.

In some embodiments, there may be: 1) a HARQ disablement which: a) does not provide low-latency mechanisms to adapt the redundancy levels of the NC and of the MCS and relies on delay-intensive higher level status reports (e.g., RLC status reports, NC sub-layer reports, PDCP status reports) or explicit CSI determination and/or reports by explicit sounding and/or reports procedures providing such information (e.g., CSI, CQI, link quality indicator (“LQI”), etc.), b) in case of low SINR relative to the protection redundancy level selected by a higher layer configuration it leads to delay bursts as the NC decoding fails only post RLC layer, incurring thus at least a 10 ms delay and exceeding the packet delay budget (“PDB”) of the XR ADUs, and c) excludes the possibility of the multiplexing other radio bearers containing non-network-coded RLC PDUs within the same TB as the network-coded content, or alternatively, of control elements from lower layers, such as MAC-CEs; and/or 2) a 1-bit HARQ ACK and/or NACK reporting per unit of transport (e.g., CBG and/or TB) which: a) may not apply to network-coded TBs, as part of the TBs that are received wrongly can be recovered by the added higher layer redundancy, and despite being able to correctly decode the information at higher layers, the PHY layer errors would report NACK which in terms would require unnecessary retransmissions at the HARQ layer, and b) may not be a sufficient report for the gNB to determine the dynamic adaptation of the NC redundancy level and/or of the MCS selection, especially given the inaccuracy of the latter mechanism as explained above.

While certain embodiments are described in the context of XR traffic, the embodiments are generally applicable to any kind of traffic bursts modelled similarly in DL by fixed periodicity with stochastic jitter with high-rate and low-latency requirements, and respectively, in UL potential periodic traffic bursts.

In certain embodiments, a receiver processes one or more received NC configurations to determine one or more CB thresholds for each partition of one or more TBs containing network-coded packets corresponding to each received NC configuration. Furthermore, such embodiments use semi-static knowledge or dynamically acquired knowledge (e.g., by means of multiplexing configurations signaling indications) of the location of non-network coded content and one or more network-coded content multiplexed in the TBs to determine non-network coded CBs of the TB that must be correctly received post-FEC decoding. Moreover, such embodiments use a determination of multiplexing knowledge and one or more determined CB thresholds to decide whether to acknowledge or not each received TB in an NC-aware and multiplexing-aware HARQ process. The decided HARQ-ACK or HARQ-NACK indication of the NC-aware and multiplexing-aware HARQ process is fed back to an original transmitter for each TB transmission.

In some embodiments, an NC-aware and multiplexing-aware HARQ procedure is capable of determining HARQ-ACK/HARQ-NACK feedback of TBs. In such embodiments, non-network-coded content (e.g., MAC-CE multiplexed elements, logical channels from other data radio bearers) is multiplexed with network-coded content (e.g., network-coded logical channels). Multiplexing of logical channels and MAC-CE elements is common in practice for maintaining a high spectral efficiency for 5G NR radio. In such embodiments, the necessity of HARQ procedures to handle both network-coded traffic and non-network-coded traffic is of high interest given deficiencies of current state-of-art HARQ baseline procedures. Moreover, in various embodiments, NC-aware and multiplexing-aware HARQ procedures provide the benefits of: 1) accurate ACK/NACK decisions regarding network-coded CBs and partitions of a TB based on knowledge of NC configuration and capability of error recovery of a higher NC sublayer; 2) reduced retransmissions by fully leveraging awareness of NC and multiplexing configurations to determine ACK/NACK of network-coded and non-network-coded CBs of a TB; 3) support for multiplexing of network-coded MAC packets with MAC-CE elements as well as other logical channels belonging to distinct data radio bearers; and/or 4) low-latency HARQ-based feedback and error recovery including NC awareness and multiplexing awareness (e.g., coding procedure, coding redundancy level, position of network-coded/non-network-coded content in the CBs of a TB, and so forth.)

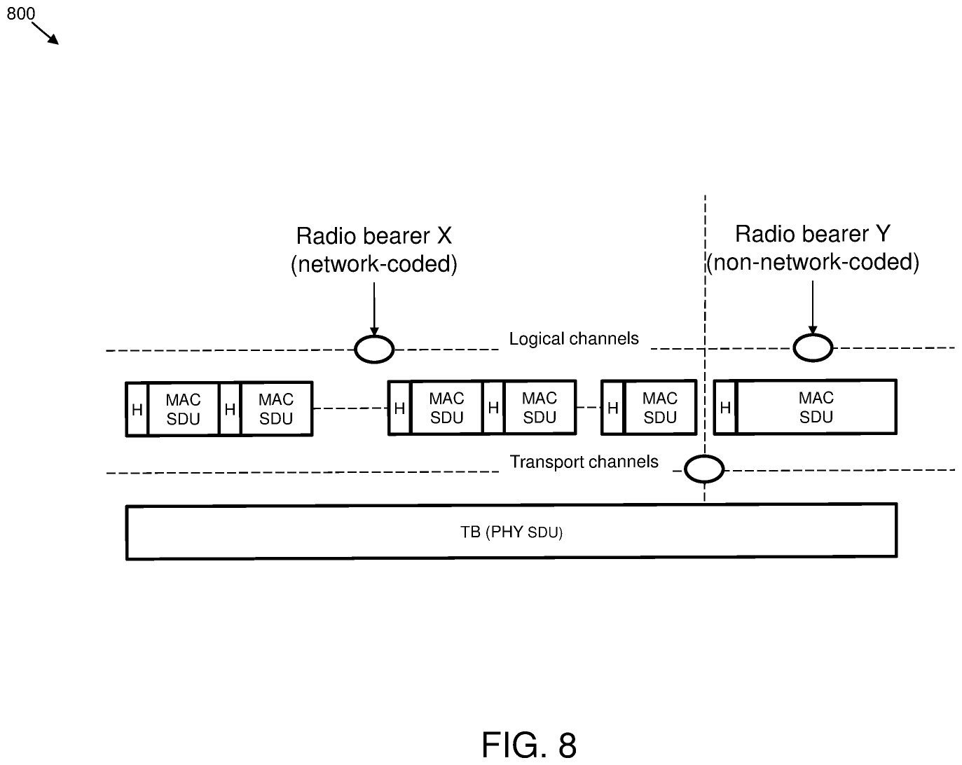

FIG. 8 is a schematic block diagram illustrating one embodiment of MAC multiplexing 800 of a network-coded logical channel with another logical channel. Each of the MAC service data units (“SDUs”) may include network-coded packets and/or symbols with a configuration NC₁ and/or NC₂. Specifically, FIG. 8 outlines one embodiment where network-coded XR DL traffic corresponding to an XR data radio bearer is multiplexed with non-network coded content or with other network-coded content corresponding to a different data radio bearer and logical channel.

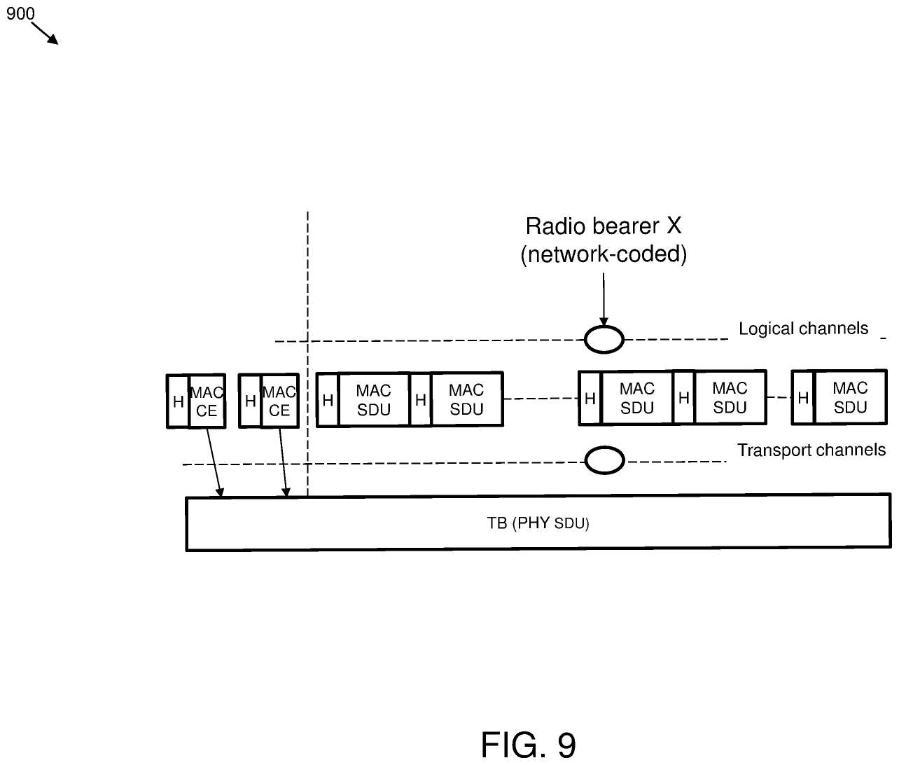

On the other hand, FIG. 9 is a schematic block diagram illustrating one embodiment of DL multiplexing 900 of a network-coded logical channel with MAC-CE elements. Each of the MAC SDUs may include network-coded packets and/or symbols with a configuration NC₁. Specifically, FIG. 9 outlines another embodiment where network-coded XR DL traffic corresponding to an XR data radio bearer is multiplexed with MAC-CE elements. As per the 5G NR MAC multiplexing of MAC-CE elements, the latter are multiplexed in DL at the beginning of a TB, whereas for UL they are multiplexed at the end of a TB.

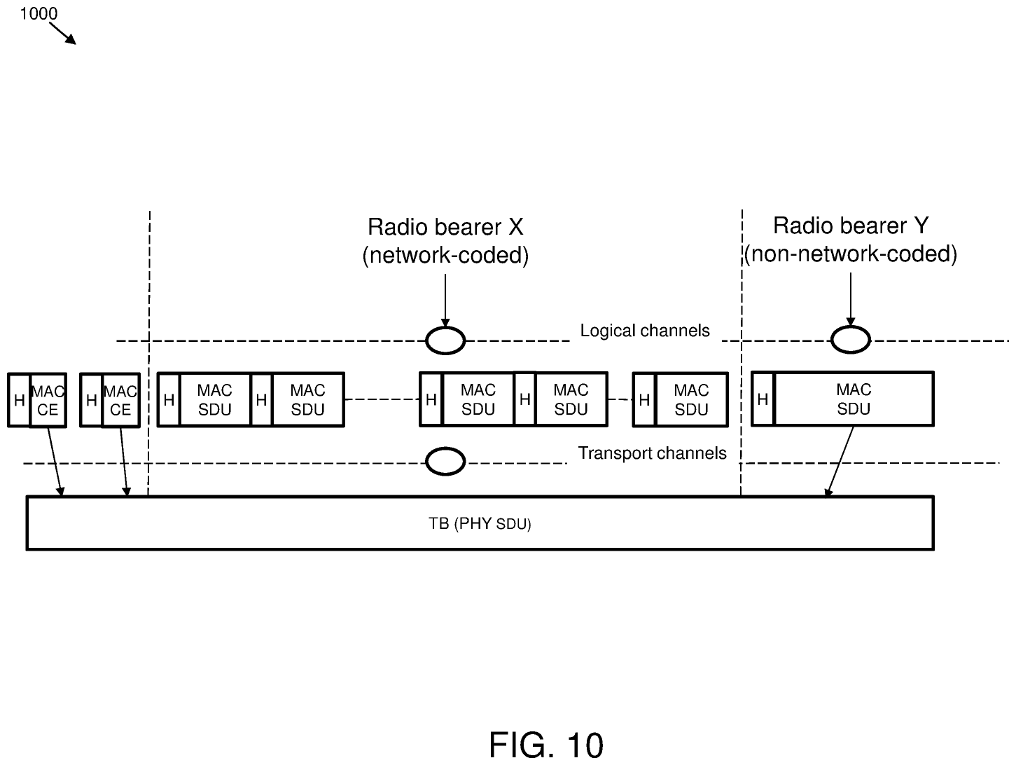

FIG. 10 is a schematic block diagram illustrating one embodiment of DL MAC multiplexing 1000 of a network-coded logical channel with MAC-CE elements and with another logical channel. Each of the MAC SDUs may include network-coded packets and/or symbols with a configuration NC₁. Specifically, a combination of MAC-CE elements, a main network-coded XR DL traffic corresponding to an XR data radio bearer, and other logical channel packets (e.g., either network-coded or not) is possible.

In one example, a gNB serving XR or CGM DL traffic to a UE indicates to the UE the configuration of the NC sub-layer by means of at least one of: 1) semi-static RRC signaling procedures; 2) dynamic signaling through DCI scheduling of PDSCH data traffic instances; 3) dynamic signaling through DCI scheduling of group PDSCH data traffic instances; and/or 4) dynamic signaling through a MAC-CE indication.

In some examples, the indication of the NC configuration may contain information detailing: an NC codebook type (e.g., Reed-Solomon, Raptor RFC 5053, RaptorQ RFC 6330, Random Linear NC, and so forth), an NC packet (or symbol) size, an NC information transmissions size, an NC information packets number, a network-coded repair packet number, a NC maximum transmission size, an NC redundancy level (e.g., determined either as a ratio of information packets number to network-coded packets number, as a ratio of network-coded repair packets number to information packets number, or as a scalar number of network-coded repair packets), and/or a number of the network-coded packets (or symbols) present in the multiplexed logical channel within a TB.

In one example, based on a received NC configuration, a UE determines an NC redundancy level and error recovery characteristics of an NC codebook. The UE further determines a CB threshold, using additional existing higher layers information of TB size (“TBS”), MCS, and DCI indicated scheduling, for determination of HARQ-ACK/HARQ-NACK of a TB containing one or more network-coded CBs. The determined CBs threshold may be in one embodiment of: 1) a necessary minimum number of correctly received CBs threshold, i.e., nCB_{correct}^{necessary}; 2) a tolerated maximum number of CB errors threshold, i.e., nCBₑᵣᵣ^{tolerated}; and/or 3) a binary functional NC indicator threshold performing a first mapping of each CB error to network-coded packets errors aggregated towards a total number network-coded packets errors, i.e., nNCₑᵣᵣ, and a second binary logic comparison to indicate whether the number of network-coded packets errors is lower or equal than a number of errors tolerated by a NC codebook for a desired reliability guarantee.

In some embodiments, for a network-coded plurality of packets as described herein, a necessary minimum number of correctly received CBs threshold, a tolerated maximum number of CB errors, and a binary functional NC indicator are analogous, and in fact reciprocal. Therefore, any determination procedures and signaling indications discussed hereafter may be equally applicable to all concepts and the detailed examples should not be considered in limitation of the overall concept.

In various embodiments, a UE configured with a multiplexing configuration dynamically indicating indices (e.g., start, stop) or an indication (e.g., start, length) relative to the CBs of a TB for each multiplexed logical channel or MAC-CE determines based on a multiplexing awareness which CBs correspond to at least one non-network-coded MAC PDU, and which CBs correspond to exclusively network-coded MAC PDUs. Therefore, post FEC decoding of the individual CBs forming the TB, the HARQ process must track and enforce bit-level correctness of the individual CBs containing at least one non-network-coded MAC PDUs, as these have no outer layer mechanisms for error correction. Thus, in such cases, the CBs must be correctly received, i.e., validate the cyclic redundancy check (“CRC”) bit field at the end of the CBs. On the other hand, in the case of CBs containing only network-coded MAC PDUs, the NC-aware and multiplexing-aware HARQ process determines whether the CB threshold determined out of the NC configuration is fulfilled as one of the necessary minimum number of correctly received CBs has been at least reached, the tolerated maximum number of CB errors has not been exceeded or a logical true value, ‘1’, has been indicated by the binary functional NC indicator. Provided that these conditions are jointly met, the reported HARQ is an ACK. Otherwise the reported HARQ is a NACK.

In some embodiments, NC-aware and multiplexing-aware CB thresholding is determined as a tolerated maximum number of CB errors threshold, as a necessary minimum number of correctly received CBs threshold, and/or as a binary functional NC indicator threshold.

Procedure 1

```
Receive one or more NC configurations of network-coded logical channels
{NC₀, NC₁, ... , NCₙ}
Receive multiplexing configuration of CBs spanned by each multiplexed logical
channel or MAC-CEs {MX₀, MX₁, ... , MXₗ}
Determine CBs thresholds for each network-coded configuration
{CB_{th,0}, CB_{th,1}, .... , CB_{th,n}} based on NC and multiplexing configurations of
network-coded logical channels as tolerated maximum number of CB errors
threshold
Set CBₑᵣᵣ [i] = 0, ∀i = {0,1, ... , n}
For each CB in TB
  If (a partition of, one or more non-network-coded PDU ∈ CB) and (CB
is erroneous)
    Return HARQ-NACK for TB
  If (a partition of, one or more non-network-coded PDU ∈ CB)
    If (CB erroneous)
      For i = 0,1, ... , n network-coded logical channel with a
partition, one or more PDUs ∈ CB
        CBₑᵣᵣ[i] = CBₑᵣᵣ[i] + 1
For any i = 0,1, ... , n NC configuration
  If (CBₑᵣᵣ [i] > CB_{th,i})
    Return HARQ-NACK for TB
Return HARQ-ACK for TB
```

Procedure 1 is a HARQ-ACK/HARQ-NACK procedure for a TB with a tolerated maximum number of CB errors threshold for NC-aware and multiplexing-aware HARQ processing of TBs with multiplexed logical channels containing at least one network-coded logical channel.

Procedure 2

```
Receive one or more NC configurations of network-coded logical channels
{NC₀, NC₁, ... , NCₙ }
Receive multiplexing configuration of CBs spanned by each multiplexed logical
channel or MAC-CEs {MX₀, MX₁, ... , MXₗ}
Determine CBs thresholds for each network-coded configuration
{CB_{(th,0)}, CB_{(th,1)}, ... . , CB_{(th,n)}} based on NC and multiplexing configurations
of network-coded logical channels as necessary minimum number of correctly
received CBs threshold
Set CB_{correct} [i] = 0, ∀i = {0,1, ... , n}
For each CB in TB
  If (a partition of, one or more non-network-coded PDU ∈ CB) and (CB
is erroneous)
    Return HARQ-NACK for TB
  If (a partition of, one or more non-network-coded PDU ∈ CB)
    If (CB not erroneous)
      For i = 0,1, ... , n network-coded logical channel with a
partition, one or more PDUs ∈ CB
        CB_{correct}[i] = CB_{correct}[i] + 1
For any i = 0,1, ... , n NC configuration
  If (CB_{correct} [i] < CB_{(th,i)})
    Return HARQ-NACK for TB
Return HARQ-ACK for TB
```

Procedure 2 is a HARQ-ACK/HARQ-NACK procedure for a TB with necessary minimum number of correctly received CBs threshold for NC-aware and multiplexing-aware HARQ processing of TBs with multiplexed logical channels containing at least one network-coded logical channel.

Procedure 3

```
Receive one or more NC configurations of network-coded logical channels
{NC₀, NC₁, ... , NCₙ }
Receive multiplexing configuration of CBs spanned by each multiplexed logical channel
or MAC-CEs {MX₀, MX₁, ... , MXₗ}
Configure a binary functional NC indicator for each network-coded configuration
{I_{(th,0)}(•), I_{(th,1)}(•), ... . , I_{(th,n)}(•)} based on NC and multiplexing configurations of
network-coded logical channels
For each CB in TB
  If (a partition of, one or more non-network-coded PDU ∈ CB) and (CB is
erroneous)
    Return HARQ-NACK for TB
  If (a partition of, one or more non-network-coded PDU ∈ CB)
    If (CB erroneous)
      For i = 0,1, ... , n network-coded logical channel with a partition,
one or more PDUs ∈ CB
        Update I_{(th,i)}(CB) with network-coded packet errors
accumulated in the CB
For any i = 0,1, ... , n NC configuration
  If (I_{(th,i)} not true)
    Return HARQ-NACK for TB
Return HARQ-ACK for TB
```

Procedure 3 is a HARQ-ACK/HARQ-NACK procedure for a TB with a binary functional NC indicator threshold for NC-aware and multiplexing-aware HARQ processing of TBs with multiplexed logical channels containing at least one network-coded logical channel.

In one example, consider 2 data radio bearers multiplexed in a DL transmission over a TBS of 100,000 bits to be transmitted over a TB with CBs configured to use low-density parity-check (“LDPC”) FEC Base Graph 1, such that 12 CBs of size 8357 bits are information carrying (e.g., including cyclic redundancy check (“CRC”) information) and transmitted over a transmission time interval (“TTI”). The first radio bearer corresponds to a network-coded logical channel carrying XR traffic, specifically a network-coded plurality of packets corresponding to an XR ADU. The second logical channel multiplexed carries generic non-network-coded data to be transmitted to the UE. An additional 2 MAC-CEs of 2 octets each (e.g., 16 bits each) are multiplexed at the beginning of the TB to indicate short buffer status reports (“BSRs”) to the UE.

In this example, consider also the first logical channel corresponding to network-coded XR traffic to be transporting N=83 network-coded packets of size 1,024 bits (128 bytes) each (e.g., corresponding to K=63 information packets of 1,024 bits each coded with a redundancy level

$$RL = ⌊ \frac{N - K}{K} ⌋ \% = 31 \% ) .$$

The combination (N,K,RL %) forms as such an example NC configuration, i.e., the NC₀ configuration. Upon encapsulation of said network-coded packets within RLC PDU (e.g., in AM mode) and MAC PDU formats respectively, the network coded packets account each for 1064 bits. Consider further the second logical channel carrying data traffic corresponding to an IP packet, which after encapsulation in the 5G NR PDCP PDU (e.g., in AM mode), RLC PDU (e.g., in AM mode) and MAC PDU formats accounts for 11560 bits.

Moreover, in this example, it follows that the 100.000 bits TBS capacity is multiplexed to contain 2 MAC-CE elements of 16 bits each, 83 network-coded MAC PDUs of 1.064 bits each corresponding to a first logical channel of an XR network-coded DL transmission, 1 MAC PDU of 11.560 bits corresponding to a second logical channel (e.g., non-network-coded), and 96 MAC padding bits, respectively. As a result, the first CB of the TB contains 2 non-network-coded MAC-CE elements and 7.8 network-coded MAC PDUs of the first logical channel. The second to last CB of the TB contains last 4.3 network-coded MAC PDUs of the first logical channel and a first chunk of the second logical channel MAC PDU payload. The last CB of the TB contains a second chunk (e.g., the remainder) of the second logical channel MAC PDU and 96 MAC padding bits (e.g., out of which the first 72 are ‘0’ bits and the last 24 bits correspond functionally to the CRC bits of the TB, according to 5G NR specification).

Further, in this example, it follows that up to N−K=20 network-coded packets of the first logical channel may be lost, yet the information still possible to be recovered. This corresponds to the proposed NC-aware and multiplexing-aware HARQ process to allow for a maximum of 2 CB errors (since 1 CB affects on average

$$8 = ⌈ \frac{8.357 - 24}{1.064} ⌉$$

network-coded MAC PDU packets) within the span of CBs, CB #1, CB #2, . . . CB #9, corresponding to the CBs containing only network-coded data, out of the CB #0, CB #1, . . . , CB #11 set forming the entire TB for an NC code (e.g., RaptorQ code) to be able to recover with very high guarantee (e.g., of at least

$$1 - \frac{1}{{256}^{1 + 2}} > 99.9999 \% )$$

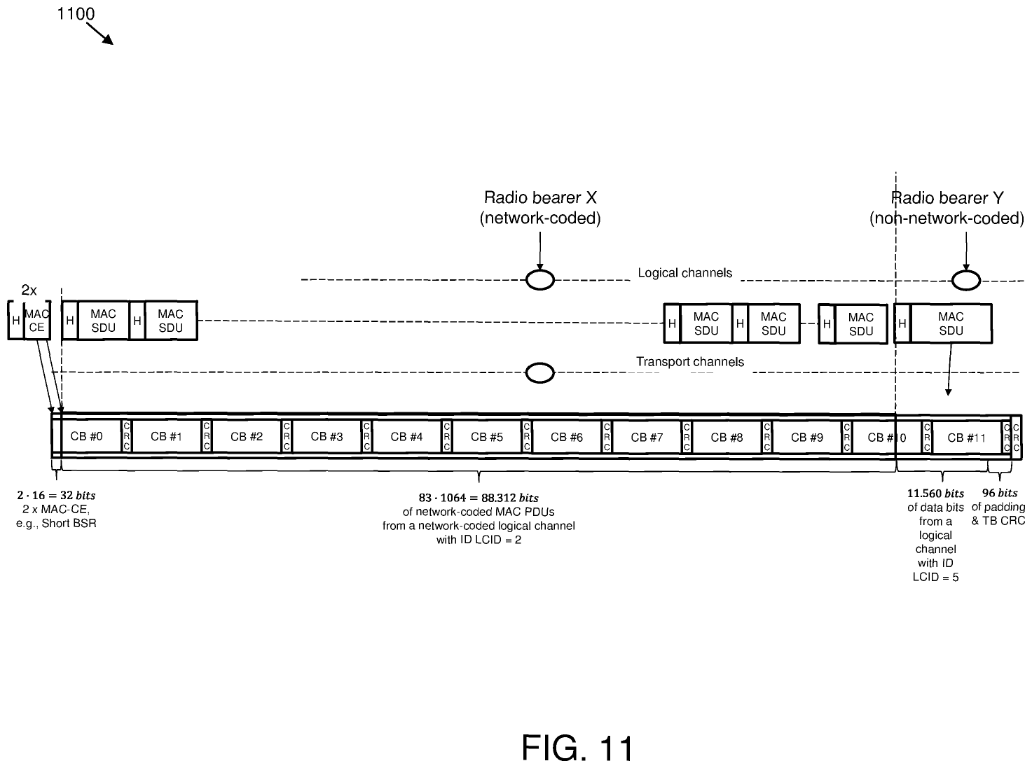

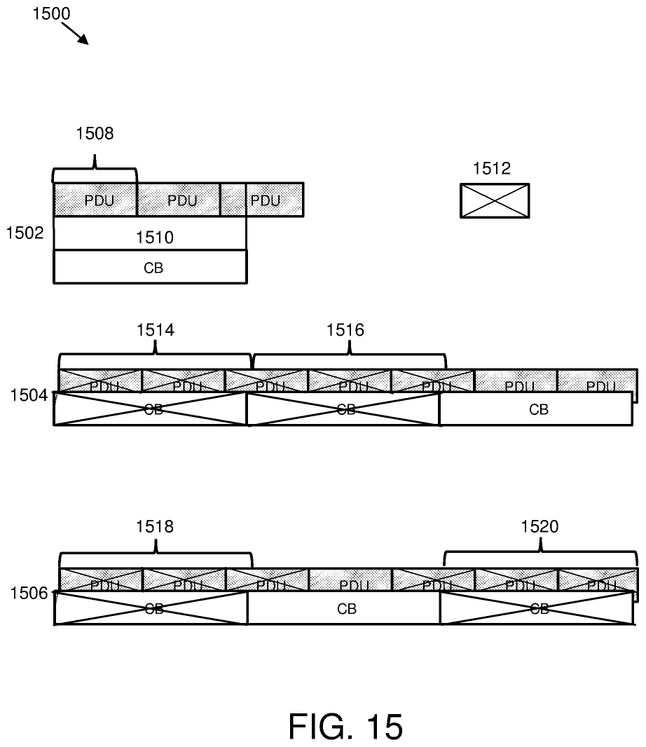

the intended transmitted information post NC decoding. The CBs, CB #0, CB #10 CB #11, must however be received correctly post FEC decoding, i.e., their CRC validation must pass, to correctly process the non-network-coded multiplexed MAC-CE elements and the second logical channel data. As such, the 2 CB prospective errors allowed by the NC-aware and multiplexing-aware HARQ procedure proposed may corrupt at least 16 network-coded MAC PDUs, if consecutive (e.g., adjacent, best-case scenario), or alternatively, at most 18 network-coded MAC PDUs, if non-consecutive (e.g., non-adjacent, worst-case scenario). It should be noted that, in case of non-consecutive CBs, the number of corrupted MAC PDUs is higher on average due to the distribution of MAC PDUs across CB boundaries, as illustrated in FIG. 15. FIG. 11 sketches the distribution of MAC PDUs across the multiplexed TB in this example. Specifically, FIG. 11 is a schematic block diagram 1100 illustrating one embodiment of TB multiplexing 2 16 bits MAC-CEs, 1 network-coded logical channel, and 1 non-network-coded logical channel. Each of the MAC SDUs of the first logical channel (e.g., corresponding to radio bearer X) include network-coded packets and/or symbols with the NC₀ configuration previously detailed.

In some embodiments, a number of allowed erroneous CBs may depend on a desired reliability guarantee for some NC codebooks of asymptotic MDS codes applied to NC (e.g., Raptor, RaptorQ codes). In one example, a NC-aware and multiplexing-aware HARQ process monitoring receiving of a TB containing at least one network-coded logical channel applies a procedure described herein and applies the determined CBs threshold (e.g., as necessary a minimum number of correctly received CBs, i.e., via Procedure 1, or as tolerated maximum number of CB errors, i.e., via Procedure 2) to determine whether the TB information can be recovered at higher layers across all logical channels and multiplexed elements. The determination of correctly received CB data post FEC decoding is done by CRC. As such, in some examples, the data that failed a CRC within a CB is considered invalid and is marked accordingly for skipping processing at higher layers, e.g., to be discarded at MAC layer post demultiplexing processing. In another example, as the MAC PDUs encapsulating the network-coded packets may not be aligned to the CB boundaries within a TB, the MAC layer identifies portions of incomplete (or corrupted) MAC PDUs based on the corrupted CBs and available NC configuration and multiplexing configurations. Therefore, an incomplete MAC PDU is a PDU at the MAC level which contains a non-void partition of erroneously received bits. Thus, the MAC demultiplexes to the upper layer's logical channels just the validly detected MAC PDUs and skips the incomplete MAC PDUs for the network-coded logical channels. As a consequence, at the RLC layer only the valid, i.e., syntactically correct network-coded RLC PDUs, are processed. The latter are processed by the NC sublayer during decoding and the original information is completely recovered given that the minimum number of required packets for reconstruction, N′≥K, have been correctly received. On the other hand, for the multiplexed non-network-coded logical channels or MAC-CE elements, the legacy processing, e.g., of 5G NR, is assumed under the proposed NC-aware and multiplexing-aware HARQ procedure.

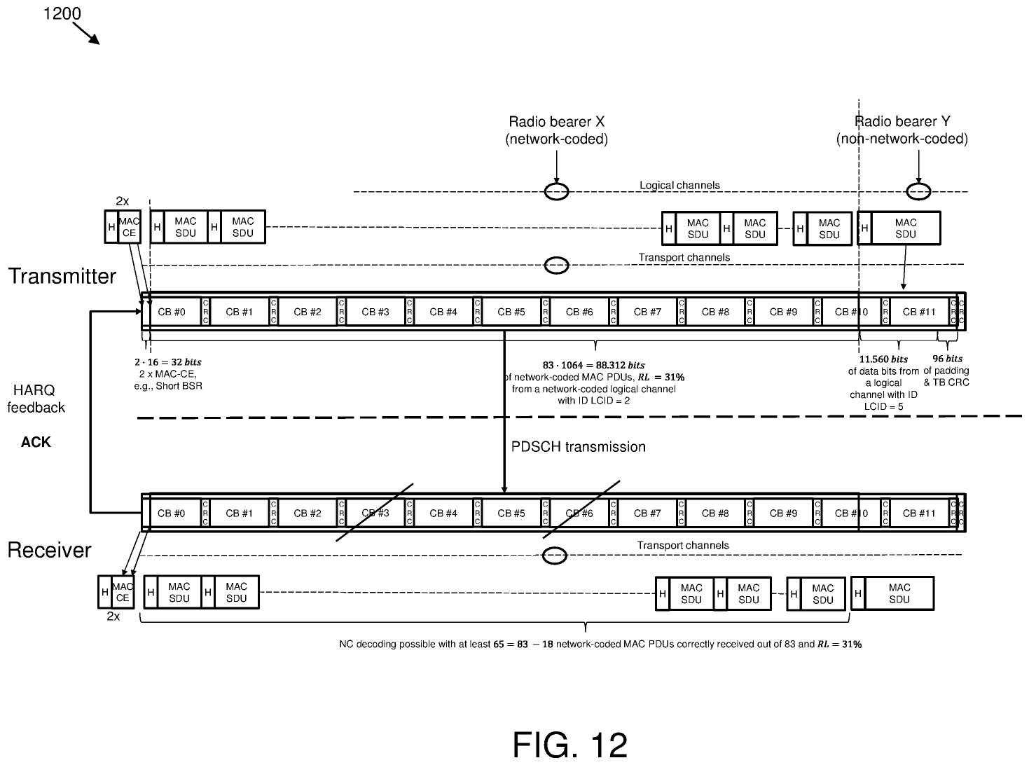

FIG. 12 is a schematic block diagram illustrating one embodiment of network-coded transmissions 1200 with HARQ-ACK feedback upon receiving a TB with some erroneous CBs less than a determined threshold based on the NC redundancy level. Each of the MAC SDUs of the first logical channel (e.g., of the radio bearer X) include network-coded packets and/or symbols with the NC₀ configuration previously detailed. Specifically, a schematic is illustrated in FIG. 12 for the case where 2 CBs out of the set CB #1, CB #2, . . . , CB #9 are corrupted resulting in at most 18 MAC PDUs being dropped, i.e., for non-consecutive CB errors, e.g., CB #3 and CB #6 as shown. Yet the NC configuration provides enough redundancy for recovery of original data at higher layers post NC decoding given that at least 65=83−18 network-coded MAC PDUs are successfully received. The HARQ feedback results thus in a HARQ ACK for the TB.

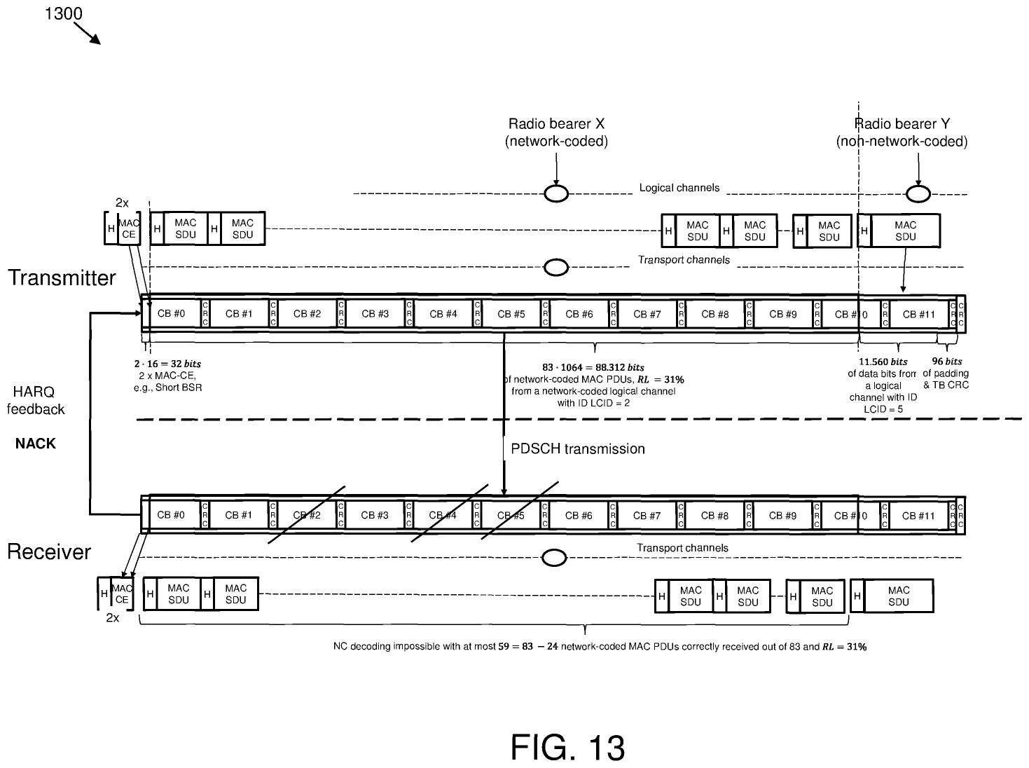

FIG. 13 is a schematic block diagram illustrating one embodiment of network-coded transmissions 1300 with HARQ-NACK feedback upon receiving a TB with some erroneous CBs more than a determined threshold based on the NC redundancy level. Each of the MAC SDUs of the first logical channel (e.g., of the radio bearer X) include network-coded packets and/or symbols with the NC₀ configuration previously detailed. In FIG. 13, the case is illustrated where 3 CBs errors, e.g., CB #2, CB #4, CB #5, within the set CB #1, CB #2, . . . , CB #9 are corrupted, resulting in at least 24 MAC PDUs being dropped at the MAC level, e.g., for the best-case scenario of 3 consecutive CBs errors. In this embodiment, the data recovery by NC decoding is impossible under the redundancy level of the considered NC configuration (i.e., N=83, K=63, RL=31%) as only 59=83-24 network-coded MAC PDUs are successfully received. The HARQ feedback corresponds thus in a HARQ NACK for the TB.

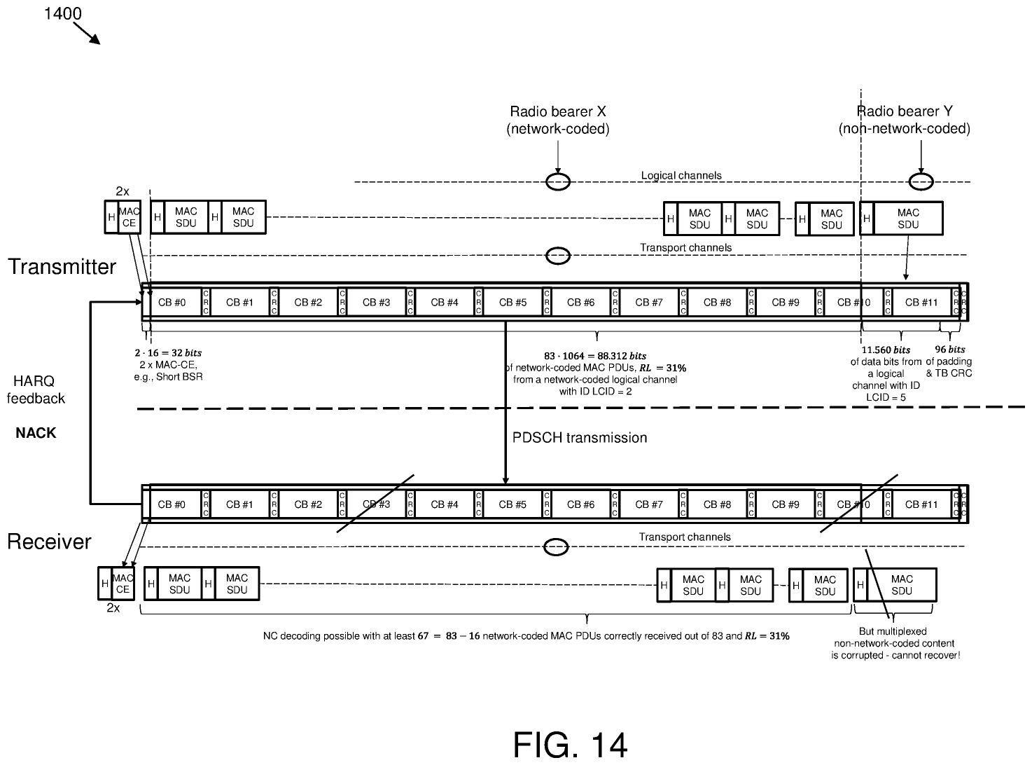

FIG. 14 is a schematic block diagram illustrating one embodiment of network-coded transmissions 1400 with HARQ-NACK feedback upon receiving a TB with one erroneous CB containing some non-network-coded logical channel data. Each of the MAC SDUs of the first logical channel (e.g., of the radio bearer X) include network-coded packets and/or symbols with the NC₀ configuration previously detailed. In FIG. 14, a first CB of the set CB #1, CB #2, . . . , CB #9, i.e., CB #3 is erroneously received, and one second CB of the set CB #0, CB #10, CB #11, i.e., CB #10, is erroneously received. Since the second erroneous CB contains a portion of a MAC PDU not protected by NC at higher layers, this results in a HARQ NACK feedback, as previously specified, even though NC decoding of the multiplexed network-coded logical channel is possible since less than 16 MAC PDUs are corrupted upon the NC and multiplexing configurations.

In certain embodiments, NC-aware and multiplexing-aware HARQ ACK is signaled even in scenarios where not all the CBs of the network-coded logical channels multiplexed in a TB are received correctly, if the number of correctly received CBs does meet the determined CBs threshold. Furthermore, via the proposed HARQ signaling, the latency of ACK/NACK feedback may be potentially decreased well under a radio frame duration (e.g., 1-10 ms) for fast signaling of failures as necessary for high-rate low-latency quasi-periodic communications such as for XR applications.

In some examples, the multiplexing configuration signaled for each MAC-CE elements and logical channels multiplexed within a TB is formed of a bit field containing at least one start indication identifying the start position of the multiplexed MAC-CE element or logical channel, and one length or stop indication identifying the stop position of the multiplexed MAC-CE element or logical channel within the TB. In another example, the multiplexing configuration is further complemented with a logical channel identifier mapping the configuration to a logical channel and/or MAC-CE element component. In other examples, the multiplexing configuration is provided in order according to the multiplexing order within the TB. In some examples, the start and/or stop indices are represented relative to the CBs, e.g., start=(1,256) or stop=(11,568) for a start within CB #1 at position 257 (e.g., assuming zero indexing) and a stop at CB #11 at position 569 (e.g., assuming zero indexing), respectively. In some examples, these indices may be quantized to fixed bit width based on the length of the CBs to reduce the required signaling whereby a trade-off between accuracy and signaling length is implicitly incurred, e.g., a position 5014 in a CB of length 8357 becomes

$$9 = ⌊ 16 \cdot \frac{5014}{8357} ⌋$$

for a 4 bit quantization. In other examples, the start and/or stop indices are represented in terms of absolute bit positions given the TBS of a TB. Implementations may consider semi-static variations thereof for indications of start/stop to reduce the number of bits necessary for reporting within a given bit field length constraint. Table 3 summarizes two examples of a {logical channel id, start, length} scheme, and of a {start, stop} scheme for the example multiplexing outlined in FIG. 11Error! Reference source not found., whereby relative CB indexing and 5G NR MAC-CE and logical channel identifier specification are considered.

TABLE 3
Examples of multiplexing configuration indications for a
multiplexing of 2 MAC-CEs, 1 network-coded logical channel
and 1 non-network-coded logical channel within a TB

| Logical channel | Multiplexing config | Multiplexing config |
|---|---|---|
| element | {LCID, start, length} | {start, stop} |
| MAC-CE element #1 | {61, (0, 0), 16} | {(0, 0), (0, 15)} |
| [LCID = 61] (Short | | |
| BSR) | | |
| MAC-CE element #2 | {61, (0, 16), 16} | {(0, 16), (0, 31)} |
| [LCID = 61] | | |
| Network-coded logical | {2, (0, 32), 88.312} | {(0, 32), (10, 5.013)} |
| channel of XR traffic | | |
| [LCID = 2] | | |
| Non-network-coded | {5, (10, 5.014), | {(10, 5.014), (12, |
| logical channel of data | 11.560} | 8.237)} |
| traffic | | |
| [LCID = 5] | | |

In some embodiments, a multiplexing configuration bit field of multiplexed logical channels elements (e.g., including MAC-CEs) is signaled at least as one of: 1) semi-statically as an RRC signaling indication; 2) dynamically as an indication in the DCI scheduling of one or more PDSCH transmissions; 3) dynamically as an indication in the DCI scheduling of one or more group PDSCH; and/or 4) dynamically as a MAC-CE indication.

In some examples, the NC-aware and multiplexing-aware HARQ feedback is explicitly enabled by a configuration field within at least one of semi-static RRC signaling, physical downlink control channel (“PDCCH”) DCI scheduling of one or more PUSCH/PDSCH transmissions, and dynamic PDCCH DCI signaling of one or more group PUSCH/PDSCH transmissions. In other examples, the NC-aware and multiplexing-aware HARQ feedback is enabled by implicitly signaling a valid NC configuration by at least one of semi-static RRC signaling, and dynamic DCI signaling for scheduling one or more PDSCH transmissions.

In a further example, the NC-aware and multiplexing-aware HARQ feedback may be completely disabled and no feedback signaling is to be performed, and the disablement of the NC- and multiplexing-aware HARQ feedback is performed by at least one of semi-static RRC signaling, and dynamic DCI signaling for scheduling one or more PDSCH transmissions.

In another example, if TBS of a TB is smaller than a threshold, the NC-aware and multiplexing-aware HARQ feedback is not provided. For instance, in one example, regular HARQ-ACK is provided for the TB. In other examples, no HARQ-ACK feedback is provided for a TB.

In one example, the NC-aware and multiplexing-aware HARQ feedback is multiplexed in a HARQ-ACK codebook that is different than the HARQ-ACK codebook associated with non-NC-aware and multiplexing-aware HARQ feedback.

In certain embodiments, determination of a CB threshold may be made by: 1) a necessary minimum number of correctly received CBs threshold, i.e., nCB_{correct}^{necessary}; 2) a tolerated maximum number of CB errors threshold, i.e., nCBₑᵣᵣ^{tolerated}; and/or 3) a binary functional NC indicator threshold performing a first mapping of accumulated CB errors to a total number network-coded packets errors, i.e., nNCₑᵣᵣ, and a second binary logic comparison to indicate whether the number of network-coded packets errors is lower or equal than a tolerated number of errors of by the NC codebook for a desired reliability guarantee.

In some embodiments, a determined one or more CB thresholds are used to decide whether a TB containing one or more multiplexed network-coded logical channels is acknowledged or not.

In one embodiment, a CB threshold may be determined as a necessary minimum number of correctly received CBs threshold including a step to: 1) determine an average number of network-coded packets per unit of CB of a TB with nCB CBs; 2) determine a necessary minimum number of correctly received CBs scalar threshold, nCB−nCB_{err,max}^{consecutive} given at least the NC configuration considering only consecutive CB errors; 3) determine a necessary maximum correctly received CBs scalar threshold, nCB−nCB_{err,max}^{nonconsecutive}, given the NC configuration considering only non-consecutive CB errors; 4) determine a necessary minimum number of correctly received CBs threshold as a tuple of two, (nCB−nCB_{err,max}^{consecutive}, nCB−nCB_{err,max}^{nonconsecutive}), formed of the necessary minimum number of correctly received CBs scalar threshold considering all erroneous CBs to be consecutive, and of the necessary minimum number of correctly received CBs scalar threshold considering all erroneous CBs to be non-consecutive; and/or 5) compress the determined necessary minimum number of correctly received CBs threshold tuple of two to a singular scalar necessary minimum number of correctly received CBs threshold as nCB_{correct}^{necessary}=max(nCB−nCB_{err,max}^{consecutive}, nCB−nCB_{err,max}^{nonconsecutive}).

In some embodiments, a necessary minimum number of correctly received CBs threshold relies therefore primarily on the network-coded packets per unit of CB of a given TB and on the average number of network-coded packets within consecutive and non-consecutive CBs. Consecutive CB errors may be defined as two or more sequential erroneous CBs, whereas a non-consecutive CB is any CB that contains at least one or more correct CBs received between itself and any other adjacent, if any, erroneous CB. From an error counting perspective, the consecutive CB errors represent the best-case scenario, whereas non-consecutive CB errors represent the worst-case scenario. This fact is a consequence of PDUs overlapping CB boundaries and double counting, as pictorially illustrated in FIG. 15.

FIG. 15 is a schematic block diagram illustrating one embodiment of timing 1500 of consecutive and non-consecutive CB errors and a mapping to network-coded packets. A baseline timing 1502 is illustrated, as well as a timing 1504 with consecutive CB errors, and a timing 1506 with non-consecutive CB errors. For the baseline timing 1502, a network-coded PDU 1508 is illustrated, and a timing 1510 of 2.33 PDU units in 1 CB. Also illustrated is an example of a corrupted packet and/or block 1512. The timing 1504 includes a first timing 1514 in which 2.33 PDUs are corrupted and a second timing 1516 in which 2.33 PDUs are corrupted (e.g., 4.66 PDUs corrupted with no double counting for a total of 5 PDUs corrupted). Moreover, the timing 1506 includes a first timing 1518 in which 3 PDUs are corrupted and a second timing 1520 in which 3 PDUs are corrupted (e.g., 6 PDUs corrupted with no PDU overlapping for a total of 6 PDUs corrupted). Specifically, FIG. 15 illustrates why the separation between consecutive and non-consecutive CBs is of relevance for the counting problem related to the determination of the necessary minimum number of correctly received CBs threshold for a CB. In one example, as displayed, 1 CB may fit 2.33 parts of a network-coded packet. In an example where 2 consecutive CBs are erroneously received, a total 4.66 parts of a network-coded packet would be corrupted, resulting into an integer total number of 5 network-coded packets to be corrupted. In another example, where 2 non-consecutive CBs are erroneously received, each CB error corrupts 2.33 parts of a network-coded packet leading to corrupting individually 3 network-coded packets each, resulting in a total number of 6 network-coded packets to be corrupted.

In one example, there may be a determination of a necessary minimum number of correctly received CBs threshold, the average network-coded number of packets per CB is computed using Equation 3, where the CBS denotes the CB size in bits and NCS denotes the network-coded packets size in bits. In an example implementation for 5G NR, the CBS may also be defined in terms of the TBS following a 5G NR specification for CB segmentation and concatenation determining the number of CBs and size thereof, whereas NCS information is extracted according to an available NC configuration.

$$PpCB = ⌈ \frac{CBS}{NCS} ⌉ \qquad Equation 3$$

In various embodiments, errors at a CB level may happen either in colocation (e.g., in consecutive CBs), or sporadically (e.g., in non-consecutive CBs). As a result, the average number of erroneous network-coded packets mapped for nCBₑᵣᵣ^{consecutive} consecutive CBs that have been erroneously received (e.g., the CRC check has failed) is upper bounded by Equation 4.

$${nNC}_{err}^{consecutive} \leq ⌈ \frac{CBS}{NCS} \cdot {nCB}_{err}^{consecutive} ⌉ , \qquad Equation 4$$

And for nCBₑᵣᵣ^{consecutive} non-consecutive CBs the mapped average number of erroneous network-coded packets is upper bounded by Equation 5.

$${nNC}_{err}^{nonconsecutive} \leq ( ⌈ \frac{CBS}{NCS} ⌉ + 1 ) \cdot {nCB}_{err}^{nonconsecutive} . \qquad Equation 5$$

In various embodiments, the upper bounds in Equation 4 and Equation 5 are meant to account for any offsets that may occur due to multiplexing across CB boundaries, hence, the ceiling operation and the unit addition.

As the total amount of network-coded packets is split between consecutive and non-consecutive CB errors, it follows that the total network-coded number of erroneous packets corresponds to Equation 6.

$${nNC}_{err}^{total} = {nNC}_{err}^{consecutive} + {nNC}_{err}^{nonconsecutive} , \qquad Equation 6$$

In certain embodiments, a minimal guarantee of recovery with high probability (e.g., 99% for RaptorQ codebooks) for a NC codebook with K input packets, N network-coded packets and N−K repair packets at a redundancy level of

$$RL \% {=}^{def} \frac{N - K}{N} \%$$

is obtained by Equation 7 or equivalently by Equation 8.

$$N - K \geq {nNC}_{err}^{total} , \qquad Equation 7$$

$$⌈ ⌊ \frac{N}{1 + \frac{RL \%}{100}} ⌋ \cdot \frac{RL \%}{100} ⌉ \geq {nNC}_{err}^{total} . \qquad Equation 8$$

In some embodiments, the minimal guarantee for recovery is thus expressed by Equation 8 in terms of N, i.e., the total number of network-coded packets, and RL %, i.e., the redundancy level of the NC code configuration, rather than N and K, i.e., the total number of information source packets.

In various embodiments, as errors may be both consecutive and non-consecutive among the CBs, it follows that nNCₑᵣᵣ^{consecutive}≤nNCₑᵣᵣ^{total}≤nNCₑᵣᵣ^{nonconsecutive} and the amount of erroneous CBs tolerated nCBₑᵣᵣ^{tolerated} is within Equation 9.

$${nNC}_{err , max}^{nonconsecutive} \leq {nNC}_{err}^{tolerated} \leq {nNC}_{err , max}^{consecutive} , \qquad Equation 9$$

In Equation 9, nCB_{err,max}^{consecutive} denotes the maximum integer number of CB consecutive errors possible satisfying inequalities Equation 4, and Equation 8 if a number of non-consecutive errors is fixed to 0, and similarly, nCB_{err,max}^{consecutive} denotes the maximum integer number of CB non-consecutive errors possible satisfying Equation 5, and Equation 8 if a number of consecutive CB errors is fixed to 0. The necessary minimum number of correctly received CBs threshold is determined as the tuple (nCB−nCB_{err,max}^{consecutive}, nCB−nCB_{err,max}^{nonconsecutive}) such as shown in Equation 10, with nCB denoting the total number of CBs within the transmitted TB.

$$nCB - {nCB}_{err , max}^{consecutive} \leq {nCB}_{correct}^{necessary} \leq nCB - {nCB}_{err , max}^{nonconsecutive} \qquad Equation 10$$

In one embodiment, a CB threshold may be determined as a tolerated maximum number of CB errors threshold with the following steps: 1) determine an average number of network-coded packets per unit of CB of a TB with nCB CBs; 2) determine a tolerated maximum number of CB errors scalar threshold, nCB_{err,max}^{consecutive}, given at least the NC configuration considering only consecutive CB errors; 3) determine a tolerated maximum number of CB errors scalar threshold, nCB_{err,max}^{nonconsecutive}, given the NC configuration considering only non-consecutive CB errors; 4) determine a tolerated maximum number of CB errors threshold as a tuple of two, (nCB_{err,max}^{nonconsecutive}, nCB_{err,max}^{consecutive}) formed of the tolerated maximum number of CB errors scalar threshold considering all erroneous CBs to be non-consecutive, and of the tolerated maximum number of CB errors scalar threshold considering all erroneous CBs to be consecutive; and/or 5) compress a determined tolerated maximum number of CB errors threshold tuple of two to a singular scalar necessary tolerated maximum number of CB errors threshold as nCB_{correct}^{necessary}=min(nCB_{err,max}^{nonconsecutive}, nCB_{err,max}^{consecutive}).

In certain embodiments, an analysis described for the determination of the necessary minimum number of correctly received CBs threshold is applicable for the determination of the tolerated maximum number of CB errors as the tuple (nCB_{err,max}^{nonconsecutive}, nCB_{err,max}^{consecutive}), according to Equation 9.

In some embodiments, simplicity of the procedures and required information to determine either a necessary minimum number of correctly received CBs threshold or a tolerated maximum number of CB errors threshold imply that the determination may be performed in some embodiments at a receiver, e.g., UE, whereas in other embodiments at a transmitter, e.g., a gNB without computing overhead.

In various embodiments, a determination of a minimum number of correctly received CBs threshold or a tolerated maximum number of CB errors threshold is done at the gNB based on additionally at least configured RRC, NC and MCS parameters. The latter are used by the gNB to extract at least necessary information of the TBS, CBS and NCS applicable for a TB during a TTI and, therefore, to explicitly determine the necessary minimum number of correctly received CBs threshold or the tolerated maximum number of CB errors threshold with TB granularity applicable to the next scheduled TTI. The determined threshold is, in some examples, indicated to the UE that will receive and process the scheduled TB by a bit field indication over at least one of a semi-static RRC signaling, a dynamic DCI scheduling of one or more PDSCH transmissions, and a dynamic MAC-CE signaling.

In some examples, a bit field indication transmitted by the network to the UE encoding the threshold for NC-aware HARQ is formed of: 1) a necessary minimum number of correctly received CBs threshold tuple (nCB−nCB_{err,max}^{consecutive}, nCB−nCB_{err,max}^{nonconsecutive}); 2) a tolerated maximum number of CB errors threshold tuple (nCB_{err,max}^{consecutive}, nCB_{err,max}^{nonconsecutive}); 3) a minimum number of correctly received CBs threshold scalar as nCB_{correct}^{necessary}=max(nCB−nCB_{err,max}^{consecutive}, nCB−nCB_{err,max}^{nonconsecutive}); and/or 4) a tolerated maximum number of CB errors threshold scalar as nCBₑᵣᵣ^{tolerated}=min(nCB_{err,max}^{nonconsecutive}, nCB_{err,max}^{consecutive}).

In one example, the bit field indication length of the NC-aware and multiplexing-aware HARQ necessary minimum number of correctly received CBs threshold (or alternatively of the tolerated maximum number of CB errors threshold) is dynamically encoded either as ┌log₂(a)+log₂(b)┐ bits for a tuple threshold of (a, b), or as a number of ┌log₂(a)┐ bits for a scalar threshold of numeric value a. In another example, the bit field indication length may be semi-statically fixed by upper layer RRC signaling describing an indexed tabular encoding of threshold possible values, whereby the bit field indication carries the index of the associated threshold value for reducing the signaling length.

In certain embodiments, a determination of a necessary minimum number of correctly received CBs threshold or a tolerated maximum number of CB errors threshold is done by the UE based on at least configured RRC, NC and MCS parameters whereby at least two of the number of network-coded packets, NC redundancy level, and the number of source data packets to undergo NC are used.

In various embodiments, advantages (e.g., simple determination procedures, sufficient information constrained mainly to NC configuration, possibility to derive both at a receiver or a transmitter) of a necessary minimum number of correctly received CBs threshold or a tolerated maximum number of CB errors threshold may constitute a trade-off against reduced accuracy, in the sense of an overestimation imposing stricter constraints than necessary. This is, in one example, a consequence of the upper bounds and methodology described throughout Equation 4 through Equation 10.

In one embodiment, a CB threshold may be determined as a binary functional NC indicator mapping performing: 1) a first mapping of each accumulated CB error to a number network-coded packet errors, i.e., nNCₑᵣᵣ^{CB}^{ᵢ}, accumulating towards a total count, i.e., nNCₑᵣᵣ, of network-coded packet errors aggregated at a TB level; and/or 2) a second binary logic comparison to indicate whether the number of network-coded packets errors at the TB level, i.e., nNCₑᵣᵣ, is lower or equal than a tolerated number of errors given a NC codebook for a desired reliability guarantee.

In one example, the binary functional NC indicator of a network-coded logical channel tracks from the receiver perspective, e.g., a UE, the receive buffers of the TB post-decoding, and first determines if a CB is erroneous, hence calculating exactly, based on a received TB multiplexing configuration, the number of network-coded packets errors aggregated towards a total number of network-coded packets errors for the network-coded logical channel. Secondly, in the same example, the aggregated total number of network-coded packets errors is compared against a received NC configuration to determine whether a tolerated maximum amount of network-coded packet errors given a desired redundancy level has been exceeded (e.g., by a greater than numeric comparison). These functional steps are enabled by applying the NC configuration specific to the tracked network-coded logical channel and the multiplexing configuration of the TB monitored.

In another example, employing a RaptorQ code with N=100 coded packets out of which N−K=25 are repair packets, a desired reliability of

$$99.99 \% = 1 + \frac{1}{{256}^{1 + h}} ,$$

i.e., h=1 is achieved by receiving r=K+1=76 network-coded packets, and as such the comparison step of the binary functional NC indicator threshold is nNCₑᵣᵣ≤24, outputting true, i.e., ‘1’, if the condition is met and false, i.e., ‘0’, otherwise.

In various embodiments, a configuration of a binary functional NC indicator threshold relies on at least a NC configuration and multiplexing configuration of a TB, and its operation depends on the state of the received and tracked TB. As such, only a receiver can determine and apply a CB threshold as a binary functional NC indicator threshold.

In certain embodiments, a determination and application of a CB threshold as the binary functional NC indicator may represent a benefit in terms of accuracy of counted network-coded packets errors in comparison to the tolerated maximum number of CB errors threshold which provide mere upper bound approximations of the latter mapped to the CB domain. On the other hand, the binary functional NC indicator threshold implies additional complexity than its counterparts given the tracking and mapping of errors from the CB domain to the network-coded packets domain.

In some embodiments, at a receiver configured with CBG-based retransmissions, one or more NC configurations corresponding to one or more logical channels multiplexed within one or more TBs and one or more multiplexing configurations corresponding to each logical channel element, e.g., MAC-CE, and logical channel data traffic may be multiplexed in each received TB. Such embodiments use at least one or more multiplexing configurations to determine the location of one or more CBs, and their corresponding CBGs containing at least some non-network-coded content that must be received correctly post FEC decoding, and respectively, to determine the location of one or more CBs, and their corresponding CBGs, containing only network-coded content. Moreover, such embodiments further use one or more NC configurations to determine one or more CB thresholds for each network-coded logical channel and use the latter together with the determined multiplexing knowledge of both network-coded content and non-network-coded content to decide in a NC-aware and multiplexing-aware HARQ process whether to acknowledge or not each CBG as part of a TB with the configured CBG-based retransmissions. The decided HARQ-ACK or HARQ-NACK indication NC-aware and multiplexing-aware HARQ process for each CBG is multiplexed per TB and reported back to an original transmitter for each TB transmission.

In various embodiments, 5G NR allows for the RRC configuration of CBG retransmissions indicated by means of DCI signaling of the CBGTI and CBGFI fields, e.g., in DCI format 1_1. CBG based retransmissions rely on grouping CBs of large TBs into CBGs uniformly according to the RRC PDSCH-CodeBlockGroupTransmission configuration parameter. The CBG retransmissions improve the spectral efficiency of the HARQ mechanism by reducing the amount of retransmission data to the CBGs where CBs have been erroneously received rather than retransmitting the TB as per the default procedure.

It should be noted that the concept of logical channels “spanning”/“comprising” one or more CBGs refers to the CBGs that encloses a partition and/or one or more PDUs belonging to the logical channel data.

In certain embodiments, if CBG-based retransmissions are enabled given a valid RRC configuration and DCI scheduling of PDSCH transmissions, the NC-aware and multiplexing-aware HARQ feedback previously specified is enhanced to produce multibit HARQ ACK/NACK feedback providing an ACK/NACK feedback bit per unit of CBG spanning the received TB. In such embodiments, the CBG-based retransmissions influence only the partitions of the TB that are to be retransmitted for recovery of the data at the PHY level and they are thus to be processed based on the NC configuration and multiplexing configuration awareness of a monitoring HARQ process.

In one example, if a CBG contains one or more CBs enclosing a partition, one or more non-network-coded MAC PDUs that have been received with errors, than the CBG is not acknowledged as there are no mechanisms available to correct for errors post FEC decoding. In such an example, the NC-aware and multiplexing-aware HARQ is HARQ-NACK for the CBG.

In another example, if a CBG contains one or more CBs enclosing a partition, one or more non-network-coded MAC PDUs that have been received correctly, the CBs in question do not necessarily require retransmissions as the non-network-coded information content has been correctly received. If all the CBs within the CBG have been received correctly, then the CBG is acknowledged with HARQ-ACK. Otherwise, if the erroneous CBs contain only network-coded content as a portion (e.g., a portion of, one or more PDU), the CBG is further processed according to the general rules in the sequel.

In one example, if CBG retransmissions are enabled and the total amount of correctly received CBs of one or more network-coded logical channels satisfy a determined NC-aware and multiplexing-aware CBs threshold, the HARQ process will report a HARQ-ACK bit for each of the CBGs regardless of any CB errors enclosed within the individual CBGs. In such scenarios no retransmissions are necessary.

In another example, where CBG retransmissions are enabled and at least one network-coded logical channel did not satisfy the determined NC-aware and multiplexing-aware CBs threshold, an NC-aware and multiplexing-aware HARQ process will rank the CBGs for each network-coded logical channel based on the enclosed number of CB (or alternatively network-coded MAC PDUs) errors. In such an example, the ranking procedure shall serve to ACK/NACK the CBGs given the existing NC configuration and multiplexing configuration. Concretely, in such embodiments the procedure follows the steps shown in Procedure 4.

Procedure 4

```
If (CB threshold, CB_{th,i}, not satisfied for i-th logical channel):
  The NC- and multiplexing-aware HARQ process sorts in descending order the CBGs
  spanned by the multiplexed network-coded i-th logical channel based on the number of
  errors they each contain (i.e., either as a number of CB errors or mapped to a number of
  network-coded packets errors)
  The top ranked one or more CBGs spanned by the i-th logical channel whose number of
  CB errors that could be corrected via retransmissions and would increase the total
  number of correct CBs/network-coded packets in the TB receive buffer to satisfy the i-
  th logical channel CBs threshold are marked as NACK
  The rest of the CBGs spanned by the t-th logical channel are marked as ACK
  The obtained NC- and multiplexing-aware HARQ feedback is multiplexed according to
  the CBG-based HARQ codebook
Else:
  All the CBGs spanned by the i-th logical channel are marked as ACK.
```

Procedure 4 is one embodiment of a short description of the CBG ranking and ACK/NACK procedure of a NC-aware and multiplexing-aware HARQ process applied to a network-coded logical channel with enabled CBG-based retransmissions.

In certain embodiments, the subroutine briefly summarized in Procedure 4 complements a general NC-aware and multiplexing-aware HARQ process high-level routine for determine HARQ-ACK/NACK feedback for CBG-based retransmissions within a Procedure 5.

Procedure 5

```
Receive one or more NC configurations of network-coded logical channels {N C₀, NC₁, ... , NCₙ}
Receive multiplexing configuration of CBs spanned by each multiplexed logical channel or
MAC-CEs {MX₀, MX₁, ... , MXₗ}
Determine CBs thresholds for each network-coded configuration {CB_{th,0}, CB_{th,1}, ... . , CB_{th,n}}
based on NC and multiplexing configurations
Reset network-coded logical channel counters // Hereby considered as error counters
Set HARQ-NACK for the all CBGs in the HARQ-ACK codebook
For each CB in TB
  If (a partition of, one or more non-network-coded PDU ∈ CB) and (CB is erroneous)
    CBG[getCbgIndex(CB)] = HARQ-NACK
  If (a partition of, one or more non-network-coded PDU ∈ CB)
    If (CB erroneous)
      For i = 0,1, ... , n network-coded logical channel with a partition, one or
more PDUs ∈ CB
        Count errors from this CB towards i-th network-coded logical
channel counter
For i = 0,1, ... , n NC configuration
  Perform CBG ranking and ACK/NACK for i-th network-coded logical channel
Return CBGs HARQ-ACK codebook
```

Procedure 5 is one embodiment of NC-aware and multiplexing-aware HARQ high-level procedure for HARQ-ACK/HARQ-NACK of a TB with CBG-enabled retransmissions and multiplexed logical channels containing at least one network-coded logical channel.

In one example, the scenario introduced in FIG. 13Error! Reference source not found. is reconsidered whereby the CBG-based retransmissions have been enabled such that the 12 CBs are grouped within 4 CBGs each containing of 3 CBs. Upon an initial transmission, CBG #0 and CBG #41 are received with errors such that 3 CBs containing only network-coded MAC PDUs are erroneous, i.e., 2 CBs in CBG #1 and 1 CB in CBG #0, respectively. In this example, the NC-aware and multiplexing-aware HARQ process determines that the 3 erroneous CBs prevent the data recovery by NC decoding of the network-coded logical channel with logical channel identifier (“LCID”)=2 given the existing NC and multiplexing configurations. The above ranking and ACK/NACK procedure is thus applied as specified above. The sorting operation results in Table 4.

TABLE 4
Ranking example of CBGs for retransmission based
on descending sorting of enclosed CB errors

| CBG ranking for | Number of erroneous | |
|---|---|---|
| retransmission | CBs | CBG identifier |
| 1 | 2 | 1 |
| 2 | 1 | 0 |
| 3 | 0 | 2 |
| 4 | 0 | 3 |

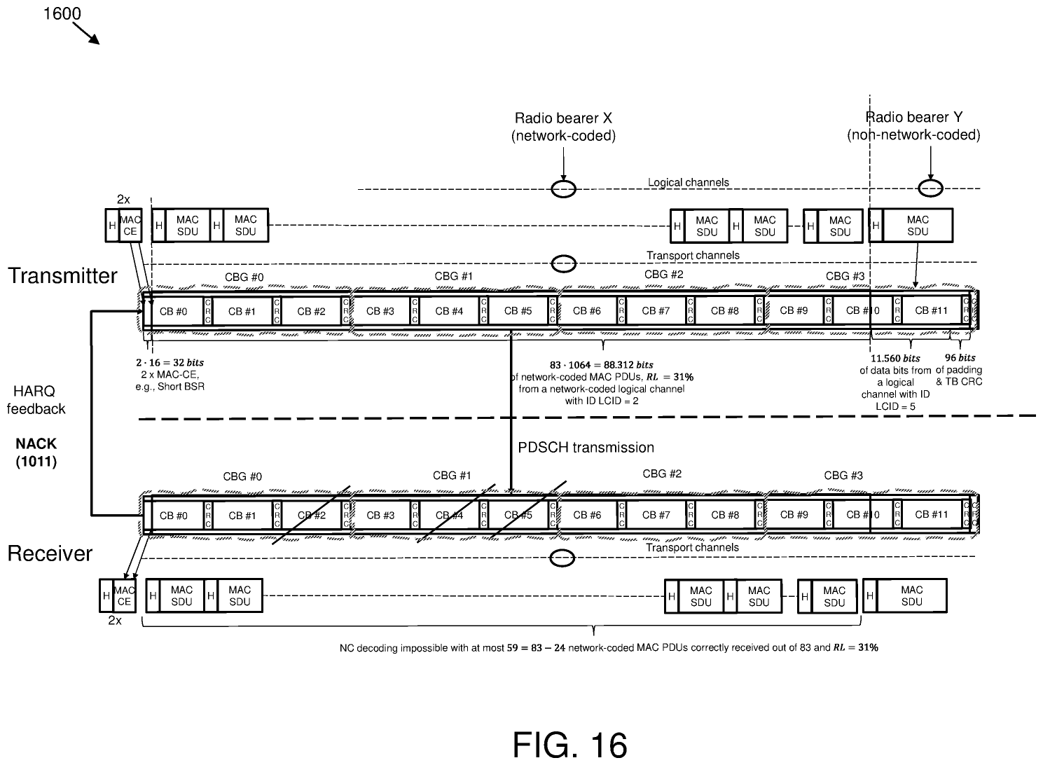

Based on the sorting, the NC-aware and multiplexing-aware HARQ process determines that retransmission of CBG #1 with 2 erroneous CBs would be sufficient to recover enough data for the NC decoding to succeed in recovering the data of the network-coded logical channel LCID=2 multiplexed within the received TB. In this example, the HARQ NACK feedback tuple (e.g., ACK, NACK, ACK, ACK) is signaled via the CBG-based HARQ-ACK codebook to the transmitter as illustrated in FIG. 16. The HARQ entity in the transmitter schedules therefore the retransmission only of the CBG #1 in response to the HARQ NACK feedback.

Specifically, FIG. 16 is a schematic block diagram illustrating one embodiment of CBG-based retransmission 1600 with NC-aware and multiplexing-aware HARQ process monitoring procedure (e.g., initial transmission). Each of the MAC SDUs of the first logical channel (e.g., of the radio bearer X) include network-coded packets and/or symbols with the NC₀ configuration previously detailed.

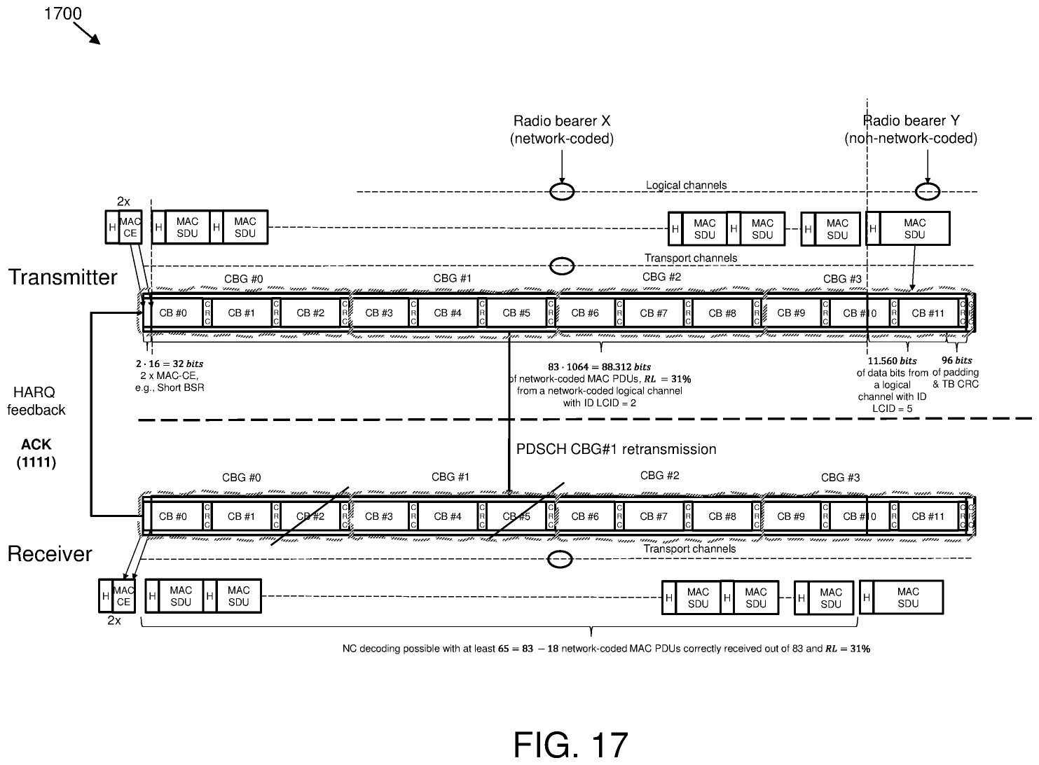

FIG. 17 is a schematic block diagram illustrating one embodiment of CBG-based retransmission with NC-aware and multiplexing-aware HARQ process monitoring procedure (e.g., CBG #1 retransmission). Each of the MAC SDUs of the first logical channel (e.g., of the radio bearer X) include network-coded packets and/or symbols with the NC₀ configuration previously detailed.

In one example of the embodiment described in FIG. 16, 1 CB, e.g., CB #5, is received with errors upon retransmission of the CBG #1 while the other 2 CBs are received correctly, as outlined in FIG. 17. As such, the NC-aware and multiplexing-aware HARQ process determines that enough correct MAC PDUs are available to recover the network-coded data of the multiplexed logical channel LCID=2 after NC decoding. Consequently, upon the specified procedure ofNC-aware and multiplexing-aware HARQ with CBG enabled, the receiver generates the HARQ ACK feedback (e.g., ACK, ACK, ACK, ACK) as a CBG HARQ-ACK codebook and as a result acknowledges the TB. Therefore, despite receiving 2 CBs with errors, the CBG-based retransmissions with NC-aware and multiplexing-aware HARQ recovers multiplexed network-coded data efficiently by retransmission of only necessary CBG resources, thus increasing spectral efficiency and decreasing latency of the HARQ retransmission procedure.

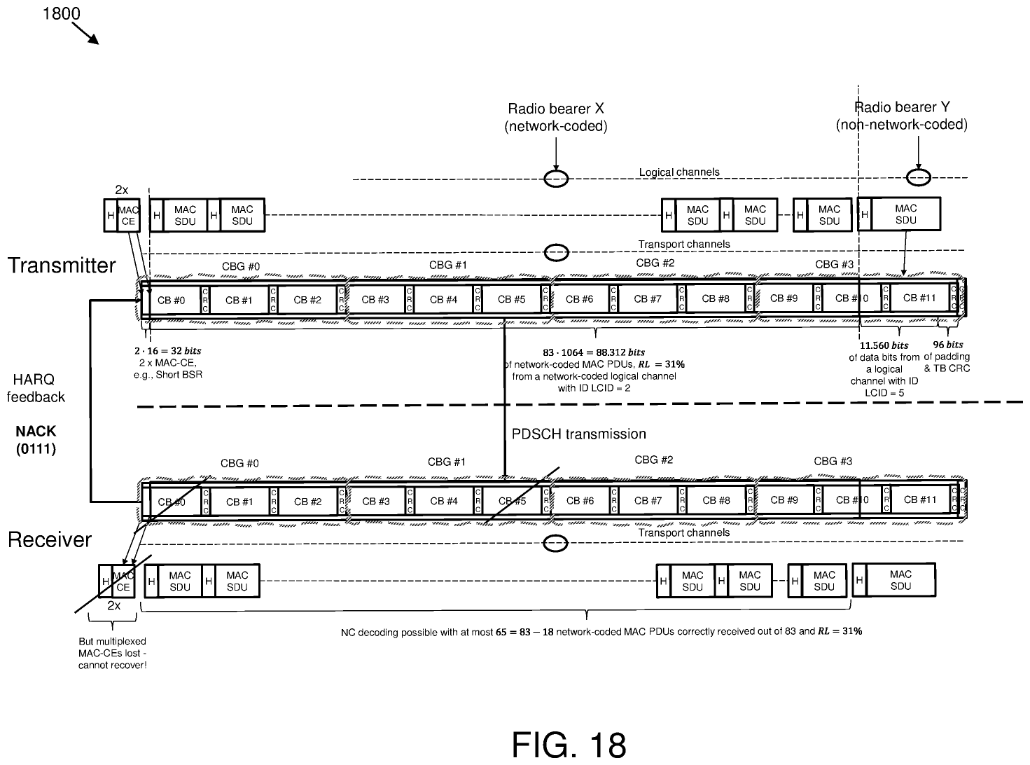

In another example, the same scenario of FIG. 13 is reconsidered with the configured CBG-based retransmissions such that the 12 CBs are grouped within 4 CBGs each containing of 3 CBs. Upon an initial transmission, CBG #0 and CBG #1 are received with errors such that 2 CBs are erroneous in total. A first erroneous CB is the CB #0, containing the two multiplexed MAC-CE elements and multiplexed network-coded MAC PDUs belonging to the network-coded logical channel with ID LCID=2. A second erroneous CB is CB #5 which contains network-coded MAC PDUs belonging to the same multiplexed network-coded logical channel with ID LCID=2. Even though NC decoding would provide the means to recover the lost data for the network-coded multiplexed logical channel, the fact that CB #0 is erroneous leads to CBG #0 being signaled as NACK. The latter is a consequence of CB #0 corruption that contains the two multiplexed MAC-CEs and may lead to their loss. CBG #0 cannot be thus acknowledged according to the described procedure for NC-aware and multiplexing-aware HARQ with CBG-based retransmissions. Therefore, the NC-aware and multiplexing-aware HARQ will multiplex the HARQ feedback according to the CBG-based HARQ codebook as (NACK, ACK, ACK, ACK) and as a result require retransmission of CBG #0. This example is illustrated in FIG. 18.

Specifically, FIG. 18 is a schematic block diagram illustrating one embodiment of CBG-based retransmission 1800 with NC-aware and multiplexing-aware HARQ process monitoring procedure for a NACKed CBG due to a CB error whereby non-network-coded logic channel data or control elements are multiplexed. Each of the MAC SDUs of the first logical channel (e.g., of the radio bearer X) include network-coded packets and/or symbols with the NC₀ configuration previously detailed.

In certain embodiment, HARQ feedback is binary in the form of ACK/NACK with reporting done per instance of HARQ process corresponding to 1 TB or 2 TBs (in case of spatial multiplexing with more than 4 layers). The HARQ procedure is controlled by a HARQ process within the HARQ entity of a ServiceCell as part of the MAC entity. The following procedure follows: 1) the MAC entity includes a HARQ entity for each serving cell, which maintains a number of parallel HARQ processes—each HARQ process is associated with a HARQ process identifier—the HARQ entity directs HARQ information and associated TBs received on the DL shared channel (“SCH”) (“DL-SCH”) to the corresponding HARQ processes; 2) the number of parallel DL HARQ processes per HARQ entity is specified—the dedicated broadcast HARQ process is used for broadcast control channel (“BCCH”)—the HARQ process supports one TB when the physical layer is not configured for downlink spatial multiplexing—the HARQ process supports one or two TBs when the physical layer is configured for downlink spatial multiplexing; and/or 3) if the MAC entity is configured with pdsch-AggregationFactor>1, the parameter pdsch-AggregationFactor provides the number of transmissions of a TB within a bundle of the downlink assignment. Bundling operation relies on the HARQ entity for invoking the same HARQ process for each transmission that is part of the same bundle. After the initial transmission, pdsch-AggregationFactor—1 HARQ retransmissions follow within a bundle.

The MAC entity shall:
1> if a downlink assignment has been indicated:
2> allocate the TB(s) received from the physical layer and the associated HARQ information to the HARQ process indicated by the associated HARQ information.
1> if a downlink assignment has been indicated for the broadcast HARQ process:
2> allocate the received TB to the broadcast HARQ process.

When a transmission takes place for the HARQ process, one or two (in case of downlink spatial multiplexing) TBs and the associated HARQ information are received from the HARQ entity.

For each received TB and associated HARQ information, the HARQ process shall:
1> if the NDI, when provided, has been toggled compared to the value of the previous received transmission corresponding to this TB; or
1> if the HARQ process is equal to the broadcast process, and this is the first received transmission for the TB according to the system information schedule indicated by RRC; or
1> if this is the very first received transmission for this TB (i.e. there is no previous new data indicator (“NDI”) for this TB):
2> consider this transmission to be a new transmission.
1> else:
2> consider this transmission to be a retransmission.

The MAC entity then shall:
1> if this is a new transmission:
2> attempt to decode the received data.
1> else if this is a retransmission:
2> if the data for this TB has not yet been successfully decoded:
3> instruct the physical layer to combine the received data with the data currently in the soft buffer for this TB and attempt to decode the combined data.
1> if the data which the MAC entity attempted to decode was successfully decoded for this TB; or
1> if the data for this TB was successfully decoded before:
2> if the HARQ process is equal to the broadcast process:
3> deliver the decoded MAC PDU to upper layers.
2> else if this is the first successful decoding of the data for this TB:
3> deliver the decoded MAC PDU to the disassembly and demultiplexing entity.
1> else:
2> instruct the physical layer to replace the data in the soft buffer for this TB with the data which the MAC entity attempted to decode.
1> if the HARQ process is associated with a transmission indicated with a Temporary cell (“C”) radio network temporary identifier (“RNTI”) (“C-RNTI”) and the Contention Resolution is not yet successful (see clause 5.1.5); or
1> if the HARQ process is associated with a transmission indicated with a message B (“MSGB”) RNTI (“MSGB-RNTI”) and the Random Access procedure is not yet successfully completed (see clause 5.1.4a); or
1> if the HARQ process is equal to the broadcast process; or
1> if the timeAlignmentTimer, associated with the TAG containing the Serving Cell on which the HARQ feedback is to be transmitted, is stopped or expired:
2> not instruct the physical layer to generate acknowledgement(s) of the data in this TB.
1> else:
2> instruct the physical layer to generate acknowledgement(s) of the data in this TB.

The MAC entity shall ignore NDI received in all downlink assignments on PDCCH for its Temporary C-RNTI when determining if NDI on PDCCH for its C-RNTI has been toggled compared to the value in the previous transmission.

It should be noted that, if the MAC entity receives a retransmission with a TB size different from the last TB size signaled for this TB, the UE behavior is left up to UE implementation.

In certain embodiments, HARQ enabling and/or disabling for DL transmissions has been considered for delay-sensitive wireless links. The non-terrestrial networks (“NTN”) problem of increased delay given the round trip time (“RTT”) incurred over the satellite links.

In some embodiments, if UL HARQ feedback is disabled, there could be issues if: 1) MAC CE and RRC signaling are not received by UE; 2) DL packets are not correctly received by UE for a long period of time without gNB knowing it.

The following may be used for NTN if HARQ feedback is disabled: 1) indicate HARQ disabling via DCI in a new and/or re-interpreted field; 2) new uplink control information (“UCI”) feedback for reporting DL transmission disruption and or requesting DL scheduling changes.

The following possible enhancements for slot-aggregation or blind repetitions may be considered for NTN: 1) greater than 8 slot-aggregation; 2) time-interleaved slot aggregation; and/or 3) new MCS table.

In various embodiments, HARQ acknowledgment (“ACK”) and/or non-acknowledgement (“NACK”) (“ACK/NACK”) reporting for DL transmissions may be multiplexed over UCI and transported over physical uplink control channel (“PUCCH”) or PUSCH. The encoding of HARQ ACK/NACK may be organized in codebooks, such as: 1) Type-1 HARQ-ACK codebook (e.g., Semi-static)—a semi-static codebook determined by the RRC configuration of HARQ timing offset, CBG-based HARQ, CCs or simultaneous TBs in transit and dynamic scheduling decisions—the number of bits to send in an ACK/NACK report is thus fixed and could be potentially large—if many component carriers are configured for instance but only a few are scheduled, this is inefficient; 2) Type-2 HARQ-ACK codebook (e.g., Dynamic)—a dynamic codebook or enhanced dynamic codebook, optimized to reduce multiplexed feedback size since the UE sends feedback only for the scheduled carriers—as in low SINR channel conditions, UE may wrongly infer the number of carriers that were scheduled, downlink assignment index as a tuple of a counter DAI (“cDAI”) and a total DAI (“tDAI”) (e.g., cDAI, tDAI) is used as part of DCI scheduling to aid the UE determine and form the dynamic HARQ feedback codebook; 3) Type-3 HARQ-ACK codebook (e.g., OneShotReporting)—the UE sends ACK/NACK report for all HARQ processes and all CCs configured in the PUCCH group in a semi-static manner given RRC configuration and parameters; and/or 4) for CBG-based HARQ-ACK codebook (e.g., CBG-level reporting), whereby the reporting is done on a per CBG level as part of the TB given an RRC configured HARQ-ACK CBG-based feedback.

In certain embodiments, HARQ may be used for multimedia services.

In some embodiments, multimedia broadcast and multicast services (“MBMS”) enhance their reliability with various HARQ feedback mechanisms.

In various embodiments, unlike LTE eMBMS and single-cell point-to-multipoint (“SC-PTM”), HARQ-ACK feedback and HARQ retransmissions are supported to achieve high reliability for multicast mode. HARQ-ACK feedback is required for gNB to know UE's reception status and perform the retransmission. However, feedback resource in PUCCH may be overloaded when many UEs are served for a multicast session. Moreover, a criterion of retransmission could be failure of reception at one UE. Based on these factors, configuration flexibility of HARQ-ACK feedback options is allowed as follows: 1) ACK/NACK based HARQ-ACK feedback: UE feedbacks ACK or NACK over a UE dedicated PUCCH resources—this mechanism may be efficient if the number of UEs receiving the multicast data is small; 2) NACK only based HARQ-ACK feedback: UE feedbacks only NACK over common PUCCH resources shared with other UEs in same group—this mechanism is resource efficient but gNB cannot detect the case that the UE fails decoding of PDCCH information; and/or 3) no HARQ-ACK feedback: UE does not send any feedback for received data. When the QoS requirement for the multicast data for UE is low, gNB can use this option to save the PUCCH resource. gNB can dynamically switch between ACK/NACK based HARQ-ACK feedback and No HARQ-ACK feedback by RRC signaling or DCI.

In certain embodiments, the RLC layer has 3 modes of operations and each with a specific PDU as follows: 1) transparent mode (“TM”), where the RLC is completely transparent and is essentially bypassed—no retransmissions, no duplicate detection, and no segmentation and/or reassembly take place—retransmissions are not feasible for these channels as there is no possibility for the device to feedback status reports as no uplink has been established; 2) unacknowledged mode (“UM”) supports segmentation but not retransmissions—this mode is used when error-free delivery is not required (e.g., voice-over IP); and/or 3) acknowledged mode (“AM”) is the main mode of operation for the DL-SCH and UL SCH (“UL-SCH”). Segmentation, duplicate removal, and retransmissions of erroneous data may all be supported.

In some embodiments, an RLC ARQ procedure is enabled only in AM operation and relies on retransmissions upon receival of RLC status reports indicating from a receiver side the failure to receive an RLC PDU based on the RLC sequence numbering. The triggering of RLC status reports is determined by a transmitter by explicit polling or by a receiver by event-based detection of misreception.

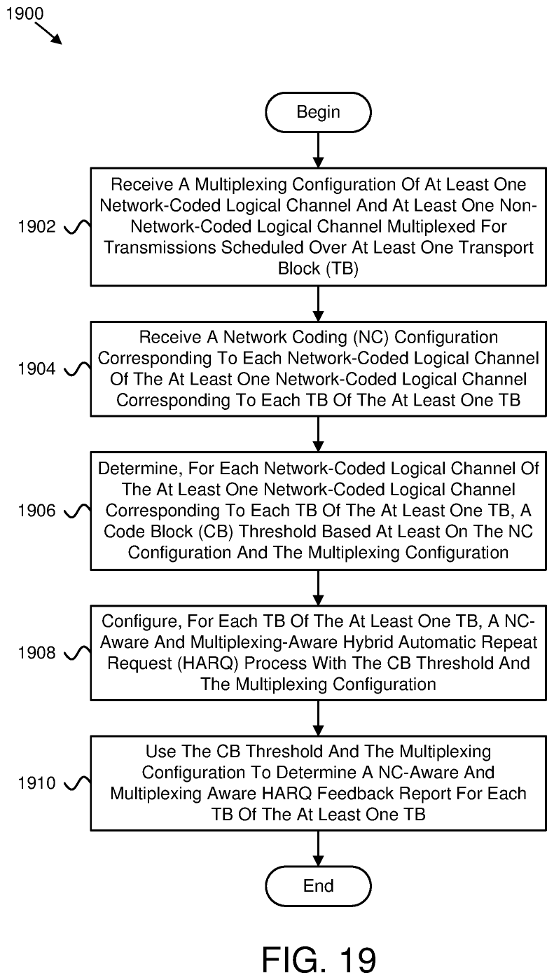

FIG. 19 is a flow chart diagram illustrating one embodiment of a method 1900 for configuring based on NC and multiplexing. In some embodiments, the method 1900 is performed by an apparatus, such as the remote unit 102. In certain embodiments, the method 1900 may be performed by a processor executing program code, for example, a microcontroller, a microprocessor, a CPU, a GPU, an auxiliary processing unit, a FPGA, or the like.

In various embodiments, the method 1900 includes receiving 1902, at a receiving device, a multiplexing configuration of at least one network-coded logical channel and at least one non-network-coded logical channel multiplexed for transmissions scheduled over at least one TB. In some embodiments, the method 1900 includes receiving 1904 a NC configuration corresponding to each network-coded logical channel of the at least one network-coded logical channel corresponding to each TB of the at least one TB. In certain embodiments, the method 1900 includes determining 1906, for each network-coded logical channel of the at least one network-coded logical channel corresponding to each TB of the at least one TB, a CB threshold based at least on the NC configuration and the multiplexing configuration. In some embodiments, the method 1900 includes configuring 1908, for each TB of the at least one TB, a NC-aware and multiplexing-aware HARQ process with the CB threshold and the multiplexing configuration. In certain embodiments, the method 1900 includes using 1910 the CB threshold and the multiplexing configuration to determine a NC-aware and multiplexing-aware HARQ feedback report for each TB of the at least one TB.

In certain embodiments, a non-network-coded logical channel of the at least one non-network-coded logical channel is represented by a medium access control (MAC) control element (CE) (MAC CE). In some embodiments, the NC configuration comprises: a type of NC codebook; a size of an NC packet; a size of an NC symbol; a number of systematic network-coded information carrying packets; a number of systematic network-coded information carrying symbols; a number of network-coded repair packets; a number of network-coded repair symbols; a total number of network-coded packets; a total number of network-coded symbols; a maximum size of a network-coded transmission; a redundancy level of the NC; a number of network-coded packets in the at least one network-coded logical channel multiplexed within each TB of the at least one TB; a number of network-coded symbols in the at least one network-coded logical channel multiplexed within each TB of the at least one TB; or some combination thereof.

In various embodiments, the NC configuration is signaled by a transmitter by: a semi-static radio resource control (RRC) signaling indication; a dynamic signaling indication of a downlink control information (DCI) scheduling at least one physical downlink shared channel (PDSCH) data traffic instance; a dynamic signaling indication of a DCI scheduling of at least one group of PDSCH data traffic instances; a dynamic MAC CE indication; or some combination thereof. In one embodiment, the multiplexing configuration encodes as a bit field for each of the at least one network-coded logical channel and the least one non-network-coded logical channel multiplexed: a start position indication; a stop position indication; a length descriptor of multiplexed logical channel content; a logical channel identifier (LCID); or some combination thereof. In certain embodiments, the method 1900 further comprises encoding the start position indication and the stop position indication as: an absolute indication at a TB level; or a relative indication to a plurality of CBs forming a TB of the at least one TB.

In some embodiments, the multiplexing configuration is signaled by a transmitter by: a semi-static RRC signaling indication; a dynamic signaling indication of a DCI scheduling at least one PDSCH data traffic instance; a dynamic signaling indication of a DCI scheduling of at least one group of PDSCH data traffic instances; a dynamic MAC CE indication; or some combination thereof. In various embodiments, the CB threshold encodes: a necessary minimum number of correctly received CB threshold; a tolerated maximum number of CB errors threshold; a binary functional NC indicator threshold; or some combination thereof. In one embodiment, a correctness of a CB is determined based on a cyclic redundancy check (CRC) comparison with a correctly received CB validating the CRC and with an erroneously received CB not validating the CRC.

In certain embodiments, determining the CB threshold comprises processing at least two of: a total number of network-coded information carrying packets; a total number of network-coded information carrying symbols; a number of source data packets to undergo NC; a number of source data symbols to undergo NC; a number of network-coded systematic information carrying packets; an NC redundancy level; one or more multiplexing configurations of logical channels multiplexed in a TB of the at least one TB; and an available RRC and modulation and coding scheme (MCS) configuration information.

In some embodiments, determining the CB threshold comprises processing: a determination of an average number of network-coded packets per CB of a TB; a determination of a tolerated maximum number of only consecutive CB errors, nCB_{err,max}^{consecutive}, given the NC configuration, wherein the consecutive CB errors represent two or more sequential erroneous CBs; a determination of a tolerated maximum number of only non-consecutive CB errors, nCB_{err,max}^{nonconsecutive}, given the NC configuration, wherein a non-consecutive erroneous CB is any CB that contains at least one correct CB received between itself and any adjacent erroneous CB; a determination of a tolerated maximum number of CB errors threshold as a tuple of two, (nCB_{err,max}^{nonconsecutive}, nCB_{err,max}^{consecutive}), formed of a tolerated maximum number of CB errors scalar threshold considering all erroneous CBs to be non-consecutive, and of the tolerated maximum number of CB errors scalar threshold considering all erroneous CBs to be consecutive; a compression of the tolerated maximum number of CB errors threshold as the tuple of two to a singular scalar of a tolerated maximum number of CB errors threshold as nCBₑᵣᵣ^{tolerated}=min(nC_{err,max}^{nonconsecutive}, nCB_{err,max}^{consecutive}); or some combination thereof.

In various embodiments, determining the CB threshold comprises processing: a determination of an average number of network-coded packets per CB of a TB of nCB CBs; a determination of a necessary minimum number of correctly received CBs scalar threshold, nCB−nCB_{err,max}^{consecutive}, given the NC configuration for only consecutive CB errors, wherein the consecutive CB errors represent two or more sequential erroneous CBs; a determination of a necessary minimum number of correctly received CBs scalar threshold, nCB−nCB_{err,max}^{nonconsecutive}, given the NC configuration for only non-consecutive CB errors, wherein a non-consecutive erroneous CB is any CB that contains at least one correct CB received between itself and any adjacent erroneous CB; a determination of a necessary minimum number of correctly received CBs threshold as a tuple of two, (nCB−nCB_{err,max}^{consecutive}, nCB−nCB_{err,max}^{nonconsecutive}) formed of the necessary minimum number of correctly received CBs scalar threshold considering all erroneous CBs to be consecutive, and of the necessary minimum number of correctly received CBs scalar threshold considering all erroneous CBs to be non-consecutive; a compression of the necessary minimum number of correctly received CBs threshold as the tuple of two to a singular scalar of a necessary minimum number of correctly received CBs threshold as nCB_{correct}^{necessary}=max(nCB−nCB_{err,max}^{consecutive}, nCB−nCB_{err,max}^{nonconsecutive}); or some combination thereof.

In one embodiment, determining the CB threshold comprises: a first mapping of each CB error to network-coded packets errors aggregated towards a number of total network-coded packet errors, i.e., nNCₑᵣᵣ; and a second binary logic comparison to indicate whether the number of total network-coded packet errors is less than or equal to a number of packet errors tolerated by the NC configuration. In certain embodiments, the CB threshold is determined based on a desired reliability guarantee given the NC configuration. In some embodiments, determining the CB threshold is performed by a transmitter and signaled to the receiver by: an RRC bit field indication made by semi-static signaling; a bit field indication made by dynamic signaling via a DCI scheduling at least one PDSCH transmission; a bit field indication made by dynamic signaling via a DCI scheduling at least one group of PDSCH transmissions; a dynamic MAC-CE bit field indication; or some combination thereof.

In various embodiments, the bit field indication comprises: a necessary minimum number of correctly received CBs threshold tuple (nCB−nCB_{err,max}^{consecutive}, nCB−nCB_{err,max}^{nonconsecutive}) a tolerated maximum number of CB errors threshold tuple (nCB_{err,max}^{nonconsecutive}, nCB_{err,max}^{consecutive}); a minimum number of correctly received CBs threshold scalar as nCB_{correct}^{necessary}; or a tolerated maximum number of CB errors threshold scalar as nCBₑᵣᵣ^{tolerated}. In one embodiment, an encoding and bit length of the bit field indication is determined by: a dynamic encoding as either ┌log₂(a)+log₂(b)┐ bits for a tuple threshold (a, b), or as ┌log₂(a)┐ bits for a scalar threshold of numeric value a; or a semi-static fixed encoding of an indexed representation signaled by upper layers describing a plurality of possible threshold values, wherein the indexed representation maps to an associated threshold value.

In certain embodiments, the NC-aware and multiplexing-aware HARQ process reports an acknowledgment (ACK) as HARQ feedback for a TB of the at least one TB in response to all CBs containing any of the at least one non-network-coded logical channel, or partitions thereof, being correctly received, and to all of the at least one network-coded logical channel meeting their determined CB threshold as: a number of correctly received CBs being greater than or equal to the CB threshold as a necessary minimum number of correctly received CBs; a number of erroneously received CBs being less than or equal to the CB threshold as a tolerated maximum number of CB errors; a number of erroneously received CBs indicating a true logical value upon application of the CB threshold as a binary functional NC indicator; or some combination thereof.

In some embodiments, the NC-aware and multiplexing-aware HARQ process reports non-acknowledgement (NACK) as HARQ feedback for a TB of the at least one TB in response to at least one CB containing any of the at least one non-network-coded logical channel, or partitions thereof, being incorrectly received, or to at least one of the at least one network-coded logical channel not meeting its determined CB threshold as: a number of correctly received CBs being less than the CB threshold as a necessary minimum number of correctly received CBs; a number of erroneously received CBs being greater than the CB threshold as a tolerated maximum number of CB errors; a number of erroneously received CBs indicating a false logical value upon application of the CB threshold as a binary functional NC indicator; or some combination thereof.

In various embodiments, the method 1900 further comprises multiplexing the NC-aware and multiplexing-aware HARQ feedback report with at least one HARQ feedback instances as: a semi-static type-1 HARQ codebook; or a dynamic type-2 HARQ codebook. In one embodiment, the method 1900 further comprises dynamically enabling the NC-aware and multiplexing-aware HARQ feedback report, disabling the NC-aware and multiplexing-aware HARQ feedback report, or a combination thereof by: a semi-static RRC signaling; a dynamic indication by a DCI scheduling at least one PDSCH transmission; a dynamic indication by a DCI scheduling at least one group of PDSCH transmissions; a dynamic MAC-CE indication; or some combination thereof. In certain embodiments, the method 1900 further comprises configuring code block group (CBG)-based retransmissions, wherein the NC-aware and multiplexing-aware HARQ feedback report is multiplexed as a CBG-based HARQ codebook.

In some embodiments, ACK is signaled for all CBGs of a TB of the at least one TB in response to all CBs containing any of the at least one non-network-coded logical channel, or partitions thereof, being correctly received, and to all of the at least one network-coded logical channel meeting their determined CB threshold as: a total number of correctly received CBs of the TB is greater than or equal to the CB threshold as a necessary minimum number of correctly received CBs; a total number of erroneously received CBs of the TB is less than or equal to the CB threshold as a tolerated maximum number of CB errors; a number of erroneously received CBs indicates a true logical value upon application of the CB threshold as a binary functional NC indicator; or some combination thereof. In various embodiments, NACK is signaled for a CBG of a TB of the at least one TB in response to the CBG comprising of at least one CB containing any of the at least one non-network-coded logical channel, or partitions thereof, being incorrectly received.

In one embodiment, NACK is signaled for at least one CBG of a TB of the at least one TB in response to at least one of the at least one network-coded logical channel not meeting its determined CB threshold as: a number of correctly received CBs being less than the CB threshold as a necessary minimum number of correctly received CBs; a number of erroneously received CBs being greater than the CB threshold as a tolerated maximum number of CB errors; a number of erroneously received CBs indicating a false logical value upon application of the CB threshold as a binary functional NC indicator; or some combination thereof. In certain embodiments, the NC-aware and multiplexing-aware HARQ process determines for each of the at least one network-coded logical channel not meeting its determined CB threshold the at least one NACK signaled CBG by: ranking all CBGs comprising the network-coded logical channel in descending order of their number of CB errors; determining a NACK for at least one top ranked CBG whose number of erroneous CBs correctable by retransmissions would lower the number of erroneous CBs to meet the network-coded logical channel CB threshold; determining an ACK for the rest of CBGs comprising the network-coded logical channel; or some combination thereof.

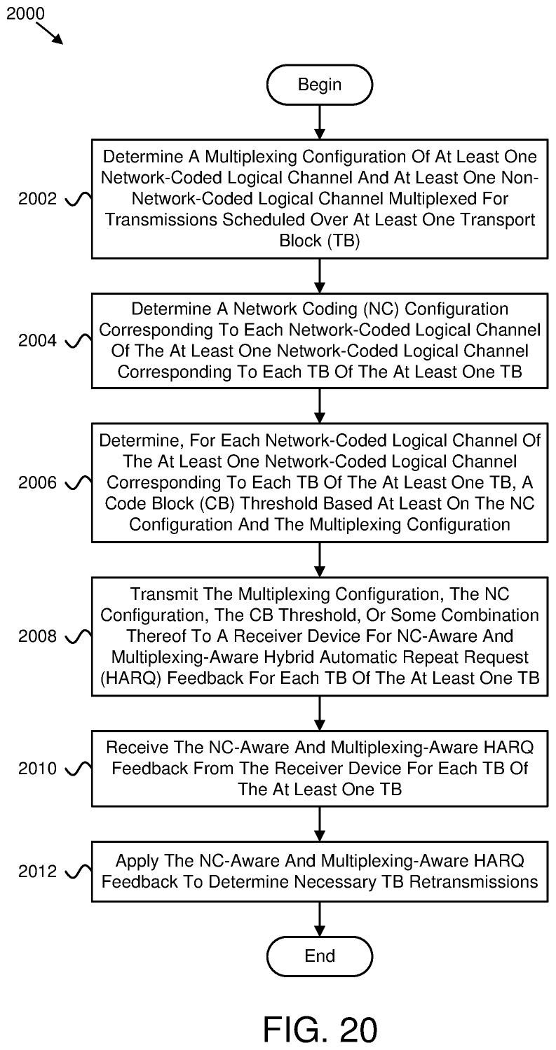

FIG. 20 is a flow chart diagram illustrating another embodiment of a method 2000 for configuring based on NC and multiplexing. In some embodiments, the method 2000 is performed by an apparatus, such as the network unit 104. In certain embodiments, the method 2000 may be performed by a processor executing program code, for example, a microcontroller, a microprocessor, a CPU, a GPU, an auxiliary processing unit, a FPGA, or the like.

In various embodiments, the method 2000 includes determining 2002, at a network device, a multiplexing configuration of at least one network-coded logical channel and at least one non-network-coded logical channel multiplexed for transmissions scheduled over at least one TB. In some embodiments, the method 2000 includes determining 2004 a NC configuration corresponding to each network-coded logical channel of the at least one network-coded logical channel corresponding to each TB of the at least one TB. In certain embodiments, the method 2000 includes determining 2006, for each network-coded logical channel of the at least one network-coded logical channel corresponding to each TB of the at least one TB, a CB threshold based at least on the NC configuration and the multiplexing configuration. In various embodiments, the method 2000 includes transmitting 2008 the multiplexing configuration, the NC configuration, the CB threshold, or some combination thereof to a receiver device for NC-aware and multiplexing-aware HARQ feedback for each TB of the at least one TB. In some embodiments, the method 2000 includes receiving 2010 the NC-aware and multiplexing-aware HARQ feedback from the receiver device for each TB of the at least one TB. In certain embodiments, the method 2000 includes applying 2012 the NC-aware and multiplexing-aware HARQ feedback to determine necessary TB retransmissions.

In certain embodiments, a non-network-coded logical channel of the at least one non-network-coded logical channel is represented by a medium access control (MAC) control element (CE) (MAC CE). In some embodiments, the NC configuration comprises: a type of NC codebook; a size of an NC packet; a size of an NC symbol; a number of systematic network-coded information carrying packets; a number of systematic network-coded information carrying symbols; a number of network-coded repair packets; a number of network-coded repair symbols; a total number of network-coded packets; a total number of network-coded symbols; a maximum size of a network-coded transmission; a redundancy level of the NC; a number of network-coded packets in the at least one network-coded logical channel multiplexed within each TB of the at least one TB; a number of network-coded symbols in the at least one network-coded logical channel multiplexed within each TB of the at least one TB; or some combination thereof.

In various embodiments, the NC configuration is signaled by: a semi-static radio resource control (RRC) signaling indication; a dynamic signaling indication of a downlink control information (DCI) scheduling at least one physical downlink shared channel (PDSCH) data traffic instance; a dynamic signaling indication of a DCI scheduling of at least one group of PDSCH data traffic instances; a dynamic MAC CE indication; or some combination thereof. In one embodiment, the multiplexing configuration encodes as a bit field for each of the at least one network-coded logical channel and the least one non-network-coded logical channel multiplexed: a start position indication; a stop position indication; a length descriptor of multiplexed logical channel content; a logical channel identifier (LCID); or some combination thereof.

In certain embodiments, the multiplexing configuration is signaled by: a semi-static RRC signaling indication; a dynamic signaling indication of a DCI scheduling at least one PDSCH data traffic instance; a dynamic signaling indication of a DCI scheduling of at least one group of PDSCH data traffic instances; a dynamic MAC CE indication; or some combination thereof. In some embodiments, the CB threshold encodes: a necessary minimum number of correctly received CB threshold; a tolerated maximum number of CB errors threshold; a binary functional NC indicator threshold; or some combination thereof. In various embodiments, determining the CB threshold comprises processing at least two of: a total number of network-coded information carrying packets; a total number of network-coded information carrying symbols; a number of source data packets to undergo NC; a number of source data symbols to undergo NC; a number of network-coded systematic information carrying packets; an NC redundancy level; one or more multiplexing configurations of logical channels multiplexed in a TB of the at least one TB; and an available RRC and modulation and coding scheme (MCS) configuration information.

In one embodiment, determining the CB threshold comprises processing: a determination of an average number of network-coded packets per CB of a TB; a determination of a tolerated maximum number of only consecutive CB errors, nCB_{err,max}^{consecutive}, given the NC configuration, wherein the consecutive CB errors represent two or more sequential erroneous CBs; a determination of a tolerated maximum number of only non-consecutive CB errors, nCB_{err,max}^{nonconsecutive}, given the NC configuration, wherein a non-consecutive erroneous CB is any CB that contains at least one correct CB received between itself and any adjacent erroneous CB; a determination of a tolerated maximum number of CB errors threshold as a tuple of two, (nCB_{err,max}^{nonconsecutive}, nCB_{err,max}^{consecutive}) formed of a tolerated maximum number of CB errors scalar threshold considering all erroneous CBs to be non-consecutive, and of the tolerated maximum number of CB errors scalar threshold considering all erroneous CBs to be consecutive; a compression of the tolerated maximum number of CB errors threshold as the tuple of two to a singular scalar of a tolerated maximum number of CB errors threshold as nCBₑᵣᵣ^{tolerated}=min(nCB_{err,max}^{nonconsecutive}, nCB_{err,max}^{consecutive}); or some combination thereof.

In certain embodiments, determining the CB threshold comprises processing: a determination of an average number of network-coded packets per CB of a TB of nCB CBs; a determination of a necessary minimum number of correctly received CBs scalar threshold, nCB−nCB_{err,max}^{consecutive}, given the NC configuration for only consecutive CB errors, wherein the consecutive CB errors represent two or more sequential erroneous CBs; a determination of a necessary minimum number of correctly received CBs scalar threshold, nCB−nCB_{err,max}^{nonconsecutive}, given the NC configuration for only non-consecutive CB errors, wherein a non-consecutive erroneous CB is any CB that contains at least one correct CB received between itself and any adjacent erroneous CB; a determination of a necessary minimum number of correctly received CBs threshold as a tuple of two, (nCB−nCB_{err,max}^{consecutive}, nCB−nCB_{err,max}^{nonconsecutive}), formed of the necessary minimum number of correctly received CBs scalar threshold considering all erroneous CBs to be consecutive, and of the necessary minimum number of correctly received CBs scalar threshold considering all erroneous CBs to be non-consecutive; a compression of the necessary minimum number of correctly received CBs threshold as the tuple of two to a singular scalar of a necessary minimum number of correctly received CBs threshold as nCB_{correct}^{necessary}=max(nCB−nCB_{err,max}^{consecutive}, nCB−nCB_{err,max}^{nonconsecutive}); or some combination thereof.

In various embodiments, the CB threshold is determined based on a desired reliability guarantee given the NC configuration. In one embodiment, the determined CB threshold is transmitted by: an RRC bit field indication made by semi-static signaling; a bit field indication made by dynamic signaling via a DCI scheduling at least one PDSCH transmission; a bit field indication made by dynamic signaling via a DCI scheduling at least one group of PDSCH transmissions; a dynamic MAC-CE bit field indication; or some combination thereof.

In certain embodiments, the bit field indication comprises: a necessary minimum number of correctly received CBs threshold tuple (nCB−nCB_{err,max}^{consecutive}, nCB−nCB_{err,max}^{nonconsecutive}); a tolerated maximum number of CB errors threshold tuple (nCB_{err,max}^{nonconsecutive}, nCB_{err,max}^{consecutive}); a minimum number of correctly received CBs threshold scalar as nCB_{correct}^{necessary}; or a tolerated maximum number of CB errors threshold scalar as nCBₑᵣᵣ^{tolerated}. In some embodiments, an encoding and bit length of the bit field indication is determined by: a dynamic encoding as either ┌log₂(a)+log₂(b)┐ bits for a tuple threshold (a, b), or as ┌log₂(a)┐ bits for a scalar threshold of numeric value a; or a semi-static fixed encoding of an indexed representation signaled by upper layers describing a plurality of possible threshold values, wherein the indexed representation maps to an associated threshold value.

In one embodiment, an apparatus comprises a receiving device. The apparatus further comprises: a receiver that: receives a multiplexing configuration of at least one network-coded logical channel and at least one non-network-coded logical channel multiplexed for transmissions scheduled over at least one TB; and receives a NC configuration corresponding to each network-coded logical channel of the at least one network-coded logical channel corresponding to each TB of the at least one TB; and a processor that: determines, for each network-coded logical channel of the at least one network-coded logical channel corresponding to each TB of the at least one TB, a CB threshold based at least on the NC configuration and the multiplexing configuration; configures, for each TB of the at least one TB, a NC-aware and multiplexing-aware HARQ process with the CB threshold and the multiplexing configuration; and uses the CB threshold and the multiplexing configuration to determine a NC-aware and multiplexing-aware HARQ feedback report for each TB of the at least one TB.

In certain embodiments, a non-network-coded logical channel of the at least one non-network-coded logical channel is represented by a medium access control (MAC) control element (CE) (MAC CE).

In some embodiments, the NC configuration comprises: a type of NC codebook; a size of an NC packet; a size of an NC symbol; a number of systematic network-coded information carrying packets; a number of systematic network-coded information carrying symbols; a number of network-coded repair packets; a number of network-coded repair symbols; a total number of network-coded packets; a total number of network-coded symbols; a maximum size of a network-coded transmission; a redundancy level of the NC; a number of network-coded packets in the at least one network-coded logical channel multiplexed within each TB of the at least one TB; a number of network-coded symbols in the at least one network-coded logical channel multiplexed within each TB of the at least one TB; or some combination thereof.

In various embodiments, the NC configuration is signaled by a transmitter by: a semi-static radio resource control (RRC) signaling indication; a dynamic signaling indication of a downlink control information (DCI) scheduling at least one physical downlink shared channel (PDSCH) data traffic instance; a dynamic signaling indication of a DCI scheduling of at least one group of PDSCH data traffic instances; a dynamic MAC CE indication; or some combination thereof.

In one embodiment, the multiplexing configuration encodes as a bit field for each of the at least one network-coded logical channel and the least one non-network-coded logical channel multiplexed: a start position indication; a stop position indication; a length descriptor of multiplexed logical channel content; a logical channel identifier (LCID); or some combination thereof.

In certain embodiments, the processor encodes the start position indication and the stop position indication as: an absolute indication at a TB level; or a relative indication to a plurality of CBs forming a TB of the at least one TB.

In some embodiments, the multiplexing configuration is signaled by a transmitter by: a semi-static RRC signaling indication; a dynamic signaling indication of a DCI scheduling at least one PDSCH data traffic instance; a dynamic signaling indication of a DCI scheduling of at least one group of PDSCH data traffic instances; a dynamic MAC CE indication; or some combination thereof.

In various embodiments, the CB threshold encodes: a necessary minimum number of correctly received CB threshold; a tolerated maximum number of CB errors threshold; a binary functional NC indicator threshold; or some combination thereof.

In one embodiment, a correctness of a CB is determined based on a cyclic redundancy check (CRC) comparison with a correctly received CB validating the CRC and with an erroneously received CB not validating the CRC.

In certain embodiments, the processor determining the CB threshold comprises the processor processing at least two of: a total number of network-coded information carrying packets; a total number of network-coded information carrying symbols; a number of source data packets to undergo NC; a number of source data symbols to undergo NC; a number of network-coded systematic information carrying packets; an NC redundancy level; one or more multiplexing configurations of logical channels multiplexed in a TB of the at least one TB; and an available RRC and modulation and coding scheme (MCS) configuration information.

In some embodiments, the processor determining the CB threshold comprises the processor processing: a determination of an average number of network-coded packets per CB of a TB; a determination of a tolerated maximum number of only consecutive CB errors, nCB_{err,max}^{consecutive}, given the NC configuration, wherein the consecutive CB errors represent two or more sequential erroneous CBs; a determination of a tolerated maximum number of only non-consecutive CB errors, nCB_{err,max}^{nonconsecutive}, given the NC configuration, wherein a non-consecutive erroneous CB is any CB that contains at least one correct CB received between itself and any adjacent erroneous CB; a determination of a tolerated maximum number of CB errors threshold as a tuple of two, (nCB_{err,max}^{nonconsecutive}, nCB_{err,max}^{consecutive}), formed of a tolerated maximum number of CB errors scalar threshold considering all erroneous CBs to be non-consecutive, and of the tolerated maximum number of CB errors scalar threshold considering all erroneous CBs to be consecutive; a compression of the tolerated maximum number of CB errors threshold as the tuple of two to a singular scalar of a tolerated maximum number of CB errors threshold as nCBₑᵣᵣ^{tolerated}=min(nCB_{err,max}^{nonconsecutive}, nCB_{err,max}^{consecutive}); or some combination thereof.

In various embodiments, the processor determining the CB threshold comprises the processor processing: a determination of an average number of network-coded packets per CB of a TB of nCB CBs; a determination of a necessary minimum number of correctly received CBs scalar threshold, nCB−nCB_{err,max}^{consecutive}, given the NC configuration for only consecutive CB errors, wherein the consecutive CB errors represent two or more sequential erroneous CBs; a determination of a necessary minimum number of correctly received CBs scalar threshold, nCB−nCB_{err,max}^{nonconsecutive}, given the NC configuration for only non-consecutive CB errors, wherein a non-consecutive erroneous CB is any CB that contains at least one correct CB received between itself and any adjacent erroneous CB; a determination of a necessary minimum number of correctly received CBs threshold as a tuple of two, (nCB−nCB_{err,max}^{consecutive}, nCB−nCB_{err,max}^{nonconsecutive}), formed of the necessary minimum number of correctly received CBs scalar threshold considering all erroneous CBs to be consecutive, and of the necessary minimum number of correctly received CBs scalar threshold considering all erroneous CBs to be non-consecutive; a compression of the necessary minimum number of correctly received CBs threshold as the tuple of two to a singular scalar of a necessary minimum number of correctly received CBs threshold as nCB_{correct}^{necessary}=max(nCB−nCB_{err,max}^{consecutive}, nCB−nCB_{err,max}^{nonconsecutive}); or some combination thereof.

In one embodiment, the processor determining the CB threshold comprises: a first mapping of each CB error to network-coded packets errors aggregated towards a number of total network-coded packet errors, i.e., nNCₑᵣᵣ; and a second binary logic comparison to indicate whether the number of total network-coded packet errors is less than or equal to a number of packet errors tolerated by the NC configuration.

In certain embodiments, the CB threshold is determined based on a desired reliability guarantee given the NC configuration.

In some embodiments, the processor determining the CB threshold is performed by a transmitter and signaled to the receiver by: an RRC bit field indication made by semi-static signaling; a bit field indication made by dynamic signaling via a DCI scheduling at least one PDSCH transmission; a bit field indication made by dynamic signaling via a DCI scheduling at least one group of PDSCH transmissions; a dynamic MAC-CE bit field indication; or some combination thereof.

In various embodiments, the bit field indication comprises: a necessary minimum number of correctly received CBs threshold tuple (nCB−nCB_{err,max}^{consecutive}, nCB−nCB_{err,max}^{nonconsecutive}); a tolerated maximum number of CB errors threshold tuple (nCB_{err,max}^{nonconsecutive}, nCB_{err,max}^{consecutive}); a minimum number of correctly received CBs threshold scalar as nCB_{correct}^{necessary}; or a tolerated maximum number of CB errors threshold scalar as correct nCBₑᵣᵣ^{tolerated}.

In one embodiment, an encoding and bit length of the bit field indication is determined by: a dynamic encoding as either ┌log₂(a)+log₂(b)┐ bits for a tuple threshold (a, b), or as ┌log₂(a)┐ bits for a scalar threshold of numeric value a; or a semi-static fixed encoding of an indexed representation signaled by upper layers describing a plurality of possible threshold values, wherein the indexed representation maps to an associated threshold value.

In certain embodiments, the NC-aware and multiplexing-aware HARQ process reports an acknowledgment (ACK) as HARQ feedback for a TB of the at least one TB in response to all CBs containing any of the at least one non-network-coded logical channel, or partitions thereof, being correctly received, and to all of the at least one network-coded logical channel meeting their determined CB threshold as: a number of correctly received CBs being greater than or equal to the CB threshold as a necessary minimum number of correctly received CBs; a number of erroneously received CBs being less than or equal to the CB threshold as a tolerated maximum number of CB errors; a number of erroneously received CBs indicating a true logical value upon application of the CB threshold as a binary functional NC indicator; or some combination thereof.

In some embodiments, the NC-aware and multiplexing-aware HARQ process reports non-acknowledgement (NACK) as HARQ feedback for a TB of the at least one TB in response to at least one CB containing any of the at least one non-network-coded logical channel, or partitions thereof, being incorrectly received, or to at least one of the at least one network-coded logical channel not meeting its determined CB threshold as: a number of correctly received CBs being less than the CB threshold as a necessary minimum number of correctly received CBs; a number of erroneously received CBs being greater than the CB threshold as a tolerated maximum number of CB errors; a number of erroneously received CBs indicating a false logical value upon application of the CB threshold as a binary functional NC indicator; or some combination thereof.

In various embodiments, the processor multiplexes the NC-aware and multiplexing-aware HARQ feedback report with at least one HARQ feedback instances as: a semi-static type-1 HARQ codebook; or a dynamic type-2 HARQ codebook.

In one embodiment, the processor dynamically enables the NC-aware and multiplexing-aware HARQ feedback report, disables the NC-aware and multiplexing-aware HARQ feedback report, or a combination thereof by: a semi-static RRC signaling; a dynamic indication by a DCI scheduling at least one PDSCH transmission; a dynamic indication by a DCI scheduling at least one group of PDSCH transmissions; a dynamic MAC-CE indication; or some combination thereof.

In certain embodiments, the processor configures code block group (CBG)-based retransmissions, and the NC-aware and multiplexing-aware HARQ feedback report is multiplexed as a CBG-based HARQ codebook.

In some embodiments, ACK is signaled for all CBGs of a TB of the at least one TB in response to all CBs containing any of the at least one non-network-coded logical channel, or partitions thereof, being correctly received, and to all of the at least one network-coded logical channel meeting their determined CB threshold as: a total number of correctly received CBs of the TB is greater than or equal to the CB threshold as a necessary minimum number of correctly received CBs; a total number of erroneously received CBs of the TB is less than or equal to the CB threshold as a tolerated maximum number of CB errors; a number of erroneously received CBs indicates a true logical value upon application of the CB threshold as a binary functional NC indicator; or some combination thereof.

In various embodiments, NACK is signaled for a CBG of a TB of the at least one TB in response to the CBG comprising of at least one CB containing any of the at least one non-network-coded logical channel, or partitions thereof, being incorrectly received.

In one embodiment, NACK is signaled for at least one CBG of a TB of the at least one TB in response to at least one of the at least one network-coded logical channel not meeting its determined CB threshold as: a number of correctly received CBs being less than the CB threshold as a necessary minimum number of correctly received CBs; a number of erroneously received CBs being greater than the CB threshold as a tolerated maximum number of CB errors; a number of erroneously received CBs indicating a false logical value upon application of the CB threshold as a binary functional NC indicator; or some combination thereof.

In certain embodiments, the NC-aware and multiplexing-aware HARQ process determines for each of the at least one network-coded logical channel not meeting its determined CB threshold the at least one NACK signaled CBG by: ranking all CBGs comprising the network-coded logical channel in descending order of their number of CB errors; determining a NACK for at least one top ranked CBG whose number of erroneous CBs correctable by retransmissions would lower the number of erroneous CBs to meet the network-coded logical channel CB threshold; determining an ACK for the rest of CBGs comprising the network-coded logical channel; or some combination thereof.

In one embodiment, a method of a receiving device comprises: receiving a multiplexing configuration of at least one network-coded logical channel and at least one non-network-coded logical channel multiplexed for transmissions scheduled over at least one TB; receiving a NC configuration corresponding to each network-coded logical channel of the at least one network-coded logical channel corresponding to each TB of the at least one TB; determining, for each network-coded logical channel of the at least one network-coded logical channel corresponding to each TB of the at least one TB, a CB threshold based at least on the NC configuration and the multiplexing configuration; configuring, for each TB of the at least one TB, a NC-aware and multiplexing-aware HARQ process with the CB threshold and the multiplexing configuration; and using the CB threshold and the multiplexing configuration to determine a NC-aware and multiplexing-aware HARQ feedback report for each TB of the at least one TB.

In certain embodiments, a non-network-coded logical channel of the at least one non-network-coded logical channel is represented by a medium access control (MAC) control element (CE) (MAC CE).

In some embodiments, the NC configuration comprises: a type of NC codebook; a size of an NC packet; a size of an NC symbol; a number of systematic network-coded information carrying packets; a number of systematic network-coded information carrying symbols; a number of network-coded repair packets; a number of network-coded repair symbols; a total number of network-coded packets; a total number of network-coded symbols; a maximum size of a network-coded transmission; a redundancy level of the NC; a number of network-coded packets in the at least one network-coded logical channel multiplexed within each TB of the at least one TB; a number of network-coded symbols in the at least one network-coded logical channel multiplexed within each TB of the at least one TB; or some combination thereof.

In various embodiments, the NC configuration is signaled by a transmitter by: a semi-static radio resource control (RRC) signaling indication; a dynamic signaling indication of a downlink control information (DCI) scheduling at least one physical downlink shared channel (PDSCH) data traffic instance; a dynamic signaling indication of a DCI scheduling of at least one group of PDSCH data traffic instances; a dynamic MAC CE indication; or some combination thereof.

In one embodiment, the multiplexing configuration encodes as a bit field for each of the at least one network-coded logical channel and the least one non-network-coded logical channel multiplexed: a start position indication; a stop position indication; a length descriptor of multiplexed logical channel content; a logical channel identifier (LCID); or some combination thereof.

In certain embodiments, the method further comprises encoding the start position indication and the stop position indication as: an absolute indication at a TB level; or a relative indication to a plurality of CBs forming a TB of the at least one TB.

In some embodiments, the multiplexing configuration is signaled by a transmitter by: a semi-static RRC signaling indication; a dynamic signaling indication of a DCI scheduling at least one PDSCH data traffic instance; a dynamic signaling indication of a DCI scheduling of at least one group of PDSCH data traffic instances; a dynamic MAC CE indication; or some combination thereof.

In various embodiments, the CB threshold encodes: a necessary minimum number of correctly received CB threshold; a tolerated maximum number of CB errors threshold; a binary functional NC indicator threshold; or some combination thereof.

In one embodiment, a correctness of a CB is determined based on a cyclic redundancy check (CRC) comparison with a correctly received CB validating the CRC and with an erroneously received CB not validating the CRC.

In certain embodiments, determining the CB threshold comprises processing at least two of: a total number of network-coded information carrying packets; a total number of network-coded information carrying symbols; a number of source data packets to undergo NC; a number of source data symbols to undergo NC; a number of network-coded systematic information carrying packets; an NC redundancy level; one or more multiplexing configurations of logical channels multiplexed in a TB of the at least one TB; and an available RRC and modulation and coding scheme (MCS) configuration information.

In some embodiments, determining the CB threshold comprises processing: a determination of an average number of network-coded packets per CB of a TB; a determination of a tolerated maximum number of only consecutive CB errors, nCB_{err,max}^{consecutive}, given the NC configuration, wherein the consecutive CB errors represent two or more sequential erroneous CBs; a determination of a tolerated maximum number of only non-consecutive CB errors, nCB_{err,max}^{nonconsecutive}, given the NC configuration, wherein a non-consecutive erroneous CB is any CB that contains at least one correct CB received between itself and any adjacent erroneous CB; a determination of a tolerated maximum number of CB errors threshold as a tuple of two, (nCB_{err,max}^{nonconsecutive}, nCB_{err,max}^{consecutive}) formed of a tolerated maximum number of CB errors scalar threshold considering all erroneous CBs to be non-consecutive, and of the tolerated maximum number of CB errors scalar threshold considering all erroneous CBs to be consecutive; a compression of the tolerated maximum number of CB errors threshold as the tuple of two to a singular scalar of a tolerated maximum number of CB errors threshold as nCBₑᵣᵣ^{tolerated}=min(nCB_{err,max}^{nonconsecutive}, nCB_{err,max}^{consecutive}); or some combination thereof.

In various embodiments, determining the CB threshold comprises processing: a determination of an average number of network-coded packets per CB of a TB of nCB CBs; a determination of a necessary minimum number of correctly received CBs scalar threshold, nCB−nCB_{err,max}^{consecutive}, given the NC configuration for only consecutive CB errors, wherein the consecutive CB errors represent two or more sequential erroneous CBs; a determination of a necessary minimum number of correctly received CBs scalar threshold, nCB−nCB_{err,max}^{nonconsecutive}, given the NC configuration for only non-consecutive CB errors, wherein a non-consecutive erroneous CB is any CB that contains at least one correct CB received between itself and any adjacent erroneous CB; a determination of a necessary minimum number of correctly received CBs threshold as a tuple of two, (nCB−nCB_{err,max}^{consecutive}, nCB−nCB_{err,max}^{nonconsecutive}), formed of the necessary minimum number of correctly received CBs scalar threshold considering all erroneous CBs to be consecutive, and of the necessary minimum number of correctly received CBs scalar threshold considering all erroneous CBs to be non-consecutive; a compression of the necessary minimum number of correctly received CBs threshold as the tuple of two to a singular scalar of a necessary minimum number of correctly received CBs threshold as nCB_{correct}^{necessary}=max(nCB−nCB_{err,max}^{consecutive}, nCB_{err,max}^{nonconsecutive}); or some combination thereof.

In one embodiment, determining the CB threshold comprises: a first mapping of each CB error to network-coded packets errors aggregated towards a number of total network-coded packet errors, i.e., nNCₑᵣᵣ; and a second binary logic comparison to indicate whether the number of total network-coded packet errors is less than or equal to a number of packet errors tolerated by the NC configuration.

In certain embodiments, the CB threshold is determined based on a desired reliability guarantee given the NC configuration.

In some embodiments, determining the CB threshold is performed by a transmitter and signaled to the receiver by: an RRC bit field indication made by semi-static signaling; a bit field indication made by dynamic signaling via a DCI scheduling at least one PDSCH transmission; a bit field indication made by dynamic signaling via a DCI scheduling at least one group of PDSCH transmissions; a dynamic MAC-CE bit field indication; or some combination thereof.

In various embodiments, the bit field indication comprises: a necessary minimum number of correctly received CBs threshold tuple (nCB−nCB_{err,max}^{consecutive}, nCB−nCB_{err,max}^{nonconsecutive}); a tolerated maximum number of CB errors threshold tuple (nCB_{err,max}^{nonconsecutive}, nCB_{err,max}^{consecutive}); a minimum number of correctly received CBs threshold scalar as nCB_{correct}^{necssary}; or a tolerated maximum number of CB errors threshold scalar as nCBₑᵣᵣ^{tolerated}.

In one embodiment, an encoding and bit length of the bit field indication is determined by: a dynamic encoding as either ┌log₂(a)+log₂(b)┐ bits for a tuple threshold (a, b), or as ┌log₂(a)┐ bits for a scalar threshold of numeric value a; or a semi-static fixed encoding of an indexed representation signaled by upper layers describing a plurality of possible threshold values, wherein the indexed representation maps to an associated threshold value.

In certain embodiments, the NC-aware and multiplexing-aware HARQ process reports an acknowledgment (ACK) as HARQ feedback for a TB of the at least one TB in response to all CBs containing any of the at least one non-network-coded logical channel, or partitions thereof, being correctly received, and to all of the at least one network-coded logical channel meeting their determined CB threshold as: a number of correctly received CBs being greater than or equal to the CB threshold as a necessary minimum number of correctly received CBs; a number of erroneously received CBs being less than or equal to the CB threshold as a tolerated maximum number of CB errors; a number of erroneously received CBs indicating a true logical value upon application of the CB threshold as a binary functional NC indicator; or some combination thereof.

In some embodiments, the NC-aware and multiplexing-aware HARQ process reports non-acknowledgement (NACK) as HARQ feedback for a TB of the at least one TB in response to at least one CB containing any of the at least one non-network-coded logical channel, or partitions thereof, being incorrectly received, or to at least one of the at least one network-coded logical channel not meeting its determined CB threshold as: a number of correctly received CBs being less than the CB threshold as a necessary minimum number of correctly received CBs; a number of erroneously received CBs being greater than the CB threshold as a tolerated maximum number of CB errors; a number of erroneously received CBs indicating a false logical value upon application of the CB threshold as a binary functional NC indicator; or some combination thereof.

In various embodiments, the method further comprises multiplexing the NC-aware and multiplexing-aware HARQ feedback report with at least one HARQ feedback instances as: a semi-static type-1 HARQ codebook; or a dynamic type-2 HARQ codebook.

In one embodiment, the method further comprises dynamically enabling the NC-aware and multiplexing-aware HARQ feedback report, disabling the NC-aware and multiplexing-aware HARQ feedback report, or a combination thereof by: a semi-static RRC signaling; a dynamic indication by a DCI scheduling at least one PDSCH transmission; a dynamic indication by a DCI scheduling at least one group of PDSCH transmissions; a dynamic MAC-CE indication; or some combination thereof.

In certain embodiments, the method further comprises configuring code block group (CBG)-based retransmissions, wherein the NC-aware and multiplexing-aware HARQ feedback report is multiplexed as a CBG-based HARQ codebook.

In some embodiments, ACK is signaled for all CBGs of a TB of the at least one TB in response to all CBs containing any of the at least one non-network-coded logical channel, or partitions thereof, being correctly received, and to all of the at least one network-coded logical channel meeting their determined CB threshold as: a total number of correctly received CBs of the TB is greater than or equal to the CB threshold as a necessary minimum number of correctly received CBs; a total number of erroneously received CBs of the TB is less than or equal to the CB threshold as a tolerated maximum number of CB errors; a number of erroneously received CBs indicates a true logical value upon application of the CB threshold as a binary functional NC indicator; or some combination thereof.

In various embodiments, NACK is signaled for a CBG of a TB of the at least one TB in response to the CBG comprising of at least one CB containing any of the at least one non-network-coded logical channel, or partitions thereof, being incorrectly received.

In one embodiment, NACK is signaled for at least one CBG of a TB of the at least one TB in response to at least one of the at least one network-coded logical channel not meeting its determined CB threshold as: a number of correctly received CBs being less than the CB threshold as a necessary minimum number of correctly received CBs; a number of erroneously received CBs being greater than the CB threshold as a tolerated maximum number of CB errors; a number of erroneously received CBs indicating a false logical value upon application of the CB threshold as a binary functional NC indicator; or some combination thereof.

In certain embodiments, the NC-aware and multiplexing-aware HARQ process determines for each of the at least one network-coded logical channel not meeting its determined CB threshold the at least one NACK signaled CBG by: ranking all CBGs comprising the network-coded logical channel in descending order of their number of CB errors; determining a NACK for at least one top ranked CBG whose number of erroneous CBs correctable by retransmissions would lower the number of erroneous CBs to meet the network-coded logical channel CB threshold; determining an ACK for the rest of CBGs comprising the network-coded logical channel; or some combination thereof.

In one embodiment, an apparatus comprises a network device. The apparatus further comprises: a processor that: determines a multiplexing configuration of at least one network-coded logical channel and at least one non-network-coded logical channel multiplexed for transmissions scheduled over at least one TB; determines a NC configuration corresponding to each network-coded logical channel of the at least one network-coded logical channel corresponding to each TB of the at least one TB; and determines, for each network-coded logical channel of the at least one network-coded logical channel corresponding to each TB of the at least one TB, a CB threshold based at least on the NC configuration and the multiplexing configuration; a transmitter that transmits the multiplexing configuration, the NC configuration, the CB threshold, or some combination thereof to a receiver device for NC-aware and multiplexing-aware HARQ feedback for each TB of the at least one TB; and a receiver that receives the NC-aware and multiplexing-aware HARQ feedback from the receiver device for each TB of the at least one TB, wherein the processor applies the NC-aware and multiplexing-aware HARQ feedback to determine necessary TB retransmissions.

In certain embodiments, a non-network-coded logical channel of the at least one non-network-coded logical channel is represented by a medium access control (MAC) control element (CE) (MAC CE).

In some embodiments, the NC configuration comprises: a type of NC codebook; a size of an NC packet; a size of an NC symbol; a number of systematic network-coded information carrying packets; a number of systematic network-coded information carrying symbols; a number of network-coded repair packets; a number of network-coded repair symbols; a total number of network-coded packets; a total number of network-coded symbols; a maximum size of a network-coded transmission; a redundancy level of the NC; a number of network-coded packets in the at least one network-coded logical channel multiplexed within each TB of the at least one TB; a number of network-coded symbols in the at least one network-coded logical channel multiplexed within each TB of the at least one TB; or some combination thereof.

In various embodiments, the NC configuration is signaled by: a semi-static radio resource control (RRC) signaling indication; a dynamic signaling indication of a downlink control information (DCI) scheduling at least one physical downlink shared channel (PDSCH) data traffic instance; a dynamic signaling indication of a DCI scheduling of at least one group of PDSCH data traffic instances; a dynamic MAC CE indication; or some combination thereof.

In one embodiment, the multiplexing configuration encodes as a bit field for each of the at least one network-coded logical channel and the least one non-network-coded logical channel multiplexed: a start position indication; a stop position indication; a length descriptor of multiplexed logical channel content; a logical channel identifier (LCID); or some combination thereof.

In certain embodiments, the multiplexing configuration is signaled by: a semi-static RRC signaling indication; a dynamic signaling indication of a DCI scheduling at least one PDSCH data traffic instance; a dynamic signaling indication of a DCI scheduling of at least one group of PDSCH data traffic instances; a dynamic MAC CE indication; or some combination thereof.

In some embodiments, the CB threshold encodes: a necessary minimum number of correctly received CB threshold; a tolerated maximum number of CB errors threshold; a binary functional NC indicator threshold; or some combination thereof.

In various embodiments, the processor determining the CB threshold comprises the processor processing at least two of: a total number of network-coded information carrying packets; a total number of network-coded information carrying symbols; a number of source data packets to undergo NC; a number of source data symbols to undergo NC; a number of network-coded systematic information carrying packets; an NC redundancy level; one or more multiplexing configurations of logical channels multiplexed in a TB of the at least one TB; and an available RRC and modulation and coding scheme (MCS) configuration information.

In one embodiment, the processor determining the CB threshold comprises the processor processing: a determination of an average number of network-coded packets per CB of a TB; a determination of a tolerated maximum number of only consecutive CB errors, nCB_{err,max}^{consecutive}, given the NC configuration, wherein the consecutive CB errors represent two or more sequential erroneous CBs; a determination of a tolerated maximum number of only non-consecutive CB errors, nCB_{err,max}^{nonconsecutive}, given the NC configuration, wherein a non-consecutive erroneous CB is any CB that contains at least one correct CB received between itself and any adjacent erroneous CB; a determination of a tolerated maximum number of CB errors threshold as a tuple of two, (nCB_{err,max}^{nonconsecutive}, nCB_{err,max}^{consecutive}), formed of a tolerated maximum number of CB errors scalar threshold considering all erroneous CBs to be non-consecutive, and of the tolerated maximum number of CB errors scalar threshold considering all erroneous CBs to be consecutive; a compression of the tolerated maximum number of CB errors threshold as the tuple of two to a singular scalar of a tolerated maximum number of CB errors threshold as nCBₑᵣᵣ^{tolerated}=min(nCB_{err,max}^{nonconsecutive}, nCB_{err,max}^{consecutive}); or some combination thereof.

In certain embodiments, the processor determining the CB threshold comprises the processor processing: a determination of an average number of network-coded packets per CB of a TB of nCB CBs; a determination of a necessary minimum number of correctly received CBs scalar threshold, nCB−nCB_{err,max}^{consecutive}, given the NC configuration for only consecutive CB errors, wherein the consecutive CB errors represent two or more sequential erroneous CBs; a determination of a necessary minimum number of correctly received CBs scalar threshold, nCB−nCB_{err,max}^{nonconsecutive}, given the NC configuration for only non-consecutive CB errors, wherein a non-consecutive erroneous CB is any CB that contains at least one correct CB received between itself and any adjacent erroneous CB; a determination of a necessary minimum number of correctly received CBs threshold as a tuple of two, (nCB−nCB_{err,max}^{consecutive}, nCB−nCB_{err,max}^{nonconsecutive}), formed of the necessary minimum number of correctly received CBs scalar threshold considering all erroneous CBs to be consecutive, and of the necessary minimum number of correctly received CBs scalar threshold considering all erroneous CBs to be non-consecutive; a compression of the necessary minimum number of correctly received CBs threshold as the tuple of two to a singular scalar of a necessary minimum number of correctly received CBs threshold as nCB_{correct}^{necessary}=max(nCB−nC_{err,max}^{consecutive}, nCB−nCB_{err,max}^{nonconsecutive}); or some combination thereof.

In various embodiments, the CB threshold is determined based on a desired reliability guarantee given the NC configuration.

In one embodiment, the processor determining the CB threshold comprises the transmitter transmitting the determined CB threshold by: an RRC bit field indication made by semi-static signaling; a bit field indication made by dynamic signaling via a DCI scheduling at least one PDSCH transmission; a bit field indication made by dynamic signaling via a DCI scheduling at least one group of PDSCH transmissions; a dynamic MAC-CE bit field indication; or some combination thereof.

In certain embodiments, the bit field indication comprises: a necessary minimum number of correctly received CBs threshold tuple (nCB−nCB_{err,max}^{consecutive}, nCB−nCB_{err,max}^{nonconsecutive}); a tolerated maximum number of CB errors threshold tuple (nCB_{err,max}^{nonconsecutive}, nCB_{err,max}^{consecutive}); a minimum number of correctly received CBs threshold scalar as nCB_{correct}^{necessary}; or a tolerated maximum number of CB errors threshold scalar as nCBₑᵣᵣ^{tolerated}.

In some embodiments, an encoding and bit length of the bit field indication is determined by: a dynamic encoding as either ┌log₂(a)+log₂(b)┐ bits for a tuple threshold (a, b), or as ┌log₂(a)┐ bits for a scalar threshold of numeric value a; or a semi-static fixed encoding of an indexed representation signaled by upper layers describing a plurality of possible threshold values, wherein the indexed representation maps to an associated threshold value.

In one embodiment, a method of a network device comprises: determining a multiplexing configuration of at least one network-coded logical channel and at least one non-network-coded logical channel multiplexed for transmissions scheduled over at least one TB; determining a NC configuration corresponding to each network-coded logical channel of the at least one network-coded logical channel corresponding to each TB of the at least one TB; determining, for each network-coded logical channel of the at least one network-coded logical channel corresponding to each TB of the at least one TB, a CB threshold based at least on the NC configuration and the multiplexing configuration; transmitting the multiplexing configuration, the NC configuration, the CB threshold, or some combination thereof to a receiver device for NC-aware and multiplexing-aware HARQ feedback for each TB of the at least one TB; receiving the NC-aware and multiplexing-aware HARQ feedback from the receiver device for each TB of the at least one TB; and applying the NC-aware and multiplexing-aware HARQ feedback to determine necessary TB retransmissions.

In certain embodiments, a non-network-coded logical channel of the at least one non-network-coded logical channel is represented by a medium access control (MAC) control element (CE) (MAC CE).

In some embodiments, the NC configuration comprises: a type of NC codebook; a size of an NC packet; a size of an NC symbol; a number of systematic network-coded information carrying packets; a number of systematic network-coded information carrying symbols; a number of network-coded repair packets; a number of network-coded repair symbols; a total number of network-coded packets; a total number of network-coded symbols; a maximum size of a network-coded transmission; a redundancy level of the NC; a number of network-coded packets in the at least one network-coded logical channel multiplexed within each TB of the at least one TB; a number of network-coded symbols in the at least one network-coded logical channel multiplexed within each TB of the at least one TB; or some combination thereof.

In various embodiments, the NC configuration is signaled by: a semi-static radio resource control (RRC) signaling indication; a dynamic signaling indication of a downlink control information (DCI) scheduling at least one physical downlink shared channel (PDSCH) data traffic instance; a dynamic signaling indication of a DCI scheduling of at least one group of PDSCH data traffic instances; a dynamic MAC CE indication; or some combination thereof.

In one embodiment, the multiplexing configuration encodes as a bit field for each of the at least one network-coded logical channel and the least one non-network-coded logical channel multiplexed: a start position indication; a stop position indication; a length descriptor of multiplexed logical channel content; a logical channel identifier (LCID); or some combination thereof.

In certain embodiments, the multiplexing configuration is signaled by: a semi-static RRC signaling indication; a dynamic signaling indication of a DCI scheduling at least one PDSCH data traffic instance; a dynamic signaling indication of a DCI scheduling of at least one group of PDSCH data traffic instances; a dynamic MAC CE indication; or some combination thereof.

In some embodiments, the CB threshold encodes: a necessary minimum number of correctly received CB threshold; a tolerated maximum number of CB errors threshold; a binary functional NC indicator threshold; or some combination thereof.

In various embodiments, determining the CB threshold comprises processing at least two of: a total number of network-coded information carrying packets; a total number of network-coded information carrying symbols; a number of source data packets to undergo NC; a number of source data symbols to undergo NC; a number of network-coded systematic information carrying packets; an NC redundancy level; one or more multiplexing configurations of logical channels multiplexed in a TB of the at least one TB; and an available RRC and modulation and coding scheme (MCS) configuration information.

In one embodiment, determining the CB threshold comprises processing: a determination of an average number of network-coded packets per CB of a TB; a determination of a tolerated maximum number of only consecutive CB errors, nCB_{err,max}^{consecutive}, given the NC configuration, wherein the consecutive CB errors represent two or more sequential erroneous CBs; a determination of a tolerated maximum number of only non-consecutive CB errors, nCB_{err,max}^{nonconsecutive}, given the NC configuration, wherein a non-consecutive erroneous CB is any CB that contains at least one correct CB received between itself and any adjacent erroneous CB; a determination of a tolerated maximum number of CB errors threshold as a tuple of two, (nCB_{err,max}^{nonconsecutive}, nCB_{err,max}^{consecutive}), formed of a tolerated maximum number of CB errors scalar threshold considering all erroneous CBs to be non-consecutive, and of the tolerated maximum number of CB errors scalar threshold considering all erroneous CBs to be consecutive; a compression of the tolerated maximum number of CB errors threshold as the tuple of two to a singular scalar of a tolerated maximum number of CB errors threshold as nCBₑᵣᵣ^{tolerated}=min(nCB_{err,max}^{nonconsecutive}, nCB_{err,max}^{consecutive}); or some combination thereof.

In certain embodiments, determining the CB threshold comprises processing: a determination of an average number of network-coded packets per CB of a TB of nCB CBs; a determination of a necessary minimum number of correctly received CBs scalar threshold, nCB−nCB_{err,max}^{consecutive}, given the NC configuration for only consecutive CB errors, wherein the consecutive CB errors represent two or more sequential erroneous CBs; a determination of a necessary minimum number of correctly received CBs scalar threshold, nCB−nCB_{err,max}^{nonconsecutive}, given the NC configuration for only non-consecutive CB errors, wherein a non-consecutive erroneous CB is any CB that contains at least one correct CB received between itself and any adjacent erroneous CB; a determination of a necessary minimum number of correctly received CBs threshold as a tuple of two, (nCB−nCB_{err,max}^{consecutive}, nCB−nCB_{err,max}^{nonconsecutive}), formed of the necessary minimum number of correctly received CBs scalar threshold considering all erroneous CBs to be consecutive, and of the necessary minimum number of correctly received CBs scalar threshold considering all erroneous CBs to be non-consecutive; a compression of the necessary minimum number of correctly received CBs threshold as the tuple of two to a singular scalar of a necessary minimum number of correctly received CBs threshold as nCB_{correct}^{necessary}=max(nCB−nCB_{err,max}^{consecutive}, nCB−nCB_{err,max}^{nonconsecutive}); or some combination thereof.

In various embodiments, the CB threshold is determined based on a desired reliability guarantee given the NC configuration.

In one embodiment, the determined CB threshold is transmitted by: an RRC bit field indication made by semi-static signaling; a bit field indication made by dynamic signaling via a DCI scheduling at least one PDSCH transmission; a bit field indication made by dynamic signaling via a DCI scheduling at least one group of PDSCH transmissions; a dynamic MAC-CE bit field indication; or some combination thereof.

In certain embodiments, the bit field indication comprises: a necessary minimum number of correctly received CBs threshold tuple (nCB−nCB_{err,max}^{consecutive}, nCB−nCB_{err,max}^{nonconsecutive}); a tolerated maximum number of CB errors threshold tuple (nCB_{err,max}^{nonconsecutive}, nCB_{err,max}^{consecutive}); a minimum number of correctly received CBs threshold scalar as nCB_{correct}^{necessary}; or a tolerated maximum number of CB errors threshold scalar as nCBₑᵣᵣ^{tolerated}.

In some embodiments, an encoding and bit length of the bit field indication is determined by: a dynamic encoding as either ┌log₂(a)+log₂(b)┐ bits for a tuple threshold (a, b), or as ┌log₂(a)┐ bits for a scalar threshold of numeric value a; or a semi-static fixed encoding of an indexed representation signaled by upper layers describing a plurality of possible threshold values, wherein the indexed representation maps to an associated threshold value.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive a multiplexing configuration of at least one network-coded logical channel and at least one non-network-coded logical channel multiplexed for transmissions scheduled over at least one transport block (TB);
receive a network coding (NC) configuration corresponding to each network-coded logical channel of the at least one network-coded logical channel corresponding to each TB of the at least one TB;
determine, for each network-coded logical channel of the at least one network-coded logical channel corresponding to each TB of the at least one TB, a code block (CB) threshold based at least on the NC configuration and the multiplexing configuration;
configure, for each TB of the at least one TB, a NC-aware and multiplexing-aware hybrid automatic repeat request (HARQ) process with the CB threshold and the multiplexing configuration; and
use the CB threshold and the multiplexing configuration to determine a NC-aware and multiplexing-aware HARQ feedback report for each TB of the at least one TB.

2. The UE of claim 1, wherein a non-network-coded logical channel of the at least one non-network-coded logical channel is represented by a medium access control (MAC) control element (CE) (MAC CE).

3. The UE of claim 1, wherein the NC configuration comprises:
a type of NC codebook;
a size of an NC packet;
a size of an NC symbol;
a number of systematic network-coded information carrying packets;
a number of systematic network-coded information carrying symbols;
a number of network-coded repair packets;
a number of network-coded repair symbols;
a total number of network-coded packets;
a total number of network-coded symbols;
a maximum size of a network-coded transmission;
a redundancy level of the NC;
a number of network-coded packets in the at least one network-coded logical channel multiplexed within each TB of the at least one TB;
a number of network-coded symbols in the at least one network-coded logical channel multiplexed within each TB of the at least one TB;
or a combination thereof.

4. The UE of claim 1, wherein the NC configuration is signaled by:
a semi-static radio resource control (RRC) signaling indication;
a dynamic signaling indication of a downlink control information (DCI) scheduling at least one physical downlink shared channel (PDSCH) data traffic instance;
a dynamic signaling indication of a DCI scheduling of at least one group of PDSCH data traffic instances;
a dynamic MAC CE indication;
or a combination thereof.

5. The UE of claim 1, wherein the multiplexing configuration encodes as a bit field for each of the at least one network-coded logical channel and the least one non-network-coded logical channel multiplexed:
a start position indication;
a stop position indication;
a length descriptor of multiplexed logical channel content;
a logical channel identifier (LCID);
or a combination thereof.

6. The UE of claim 5, wherein the at least one processor is configured to cause the UE to encode the start position indication and the stop position indication as:
an absolute indication at a TB level; or
a relative indication to a plurality of CBs forming a TB of the at least one TB.

7. The UE of claim 1, wherein the multiplexing configuration is signaled by:
a semi-static RRC signaling indication;
a dynamic signaling indication of a DCI scheduling at least one PDSCH data traffic instance;
a dynamic signaling indication of a DCI scheduling of at least one group of PDSCH data traffic instances;
a dynamic MAC CE indication;
or a combination thereof.

8. The UE of claim 1, wherein the CB threshold encodes:
a necessary minimum number of correctly received CB threshold;
a tolerated maximum number of CB errors threshold;
a binary functional NC indicator threshold;
or a combination thereof.

9. The UE of claim 8, wherein a correctness of a CB is determined based on a cyclic redundancy check (CRC) comparison with a correctly received CB validating the CRC and with an erroneously received CB not validating the CRC.

10. The UE of claim 1, wherein the at least one processor is configured to cause the UE to process at least two of:
a total number of network-coded information carrying packets;
a total number of network-coded information carrying symbols;
a number of source data packets to undergo NC;
a number of source data symbols to undergo NC;
a number of network-coded systematic information carrying packets;
an NC redundancy level;
one or more multiplexing configurations of logical channels multiplexed in a TB of the at least one TB; and
an available RRC and modulation and coding scheme (MCS) configuration information.

11. The UE of claim 1, wherein the at least one processor is configured to cause the UE to process:
a determination of an average number of network-coded packets per CB of a TB;
a determination of a tolerated maximum number of only consecutive CB errors, nCB_{err,max}^{consecutive}, given the NC configuration, wherein the consecutive CB errors represent two or more sequential erroneous CBs;
a determination of a tolerated maximum number of only non-consecutive CB errors, nCB_{err,max}^{nonconsecutive}, given the NC configuration, wherein a non-consecutive erroneous CB is any CB that contains at least one correct CB received between itself and any adjacent erroneous CB;
a determination of a tolerated maximum number of CB errors threshold as a tuple of two, (nCB_{err,max}^{nonconsecutive}, nCB_{err,max}^{consecutive}), formed of a tolerated maximum number of CB errors scalar threshold considering all erroneous CBs to be non-consecutive, and of the tolerated maximum number of CB errors scalar threshold considering all erroneous CBs to be consecutive;
a compression of the tolerated maximum number of CB errors threshold as the tuple of two to a singular scalar of a tolerated maximum number of CB errors threshold as nCBₑᵣᵣ^{tolerated}=min(nCB_{err,max}^{nonconsecutive}, nCB_{err,max}^{consecutive});
or a combination thereof.

12. The UE of claim 1, wherein the at least one processor is configured to cause the UE to process:
a determination of an average number of network-coded packets per CB of a TB of nCB CBs;
a determination of a necessary minimum number of correctly received CBs scalar threshold, nCB−nCB_{err,max}^{consecutive}, given the NC configuration for only consecutive CB errors, wherein the consecutive CB errors represent two or more sequential erroneous CBs;
a determination of a necessary minimum number of correctly received CBs scalar threshold, nCB−nCB_{err,max}^{nonconsecutive}, given the NC configuration for only non-consecutive CB errors, wherein a non-consecutive erroneous CB is any CB that contains at least one correct CB received between itself and any adjacent erroneous CB;
a determination of a necessary minimum number of correctly received CBs threshold as a tuple of two, (nCB−nCB_{err,max}^{consecutive}, nCB−nCB_{err,max}^{nonconsecutive}), formed of the necessary minimum number of correctly received CBs scalar threshold considering all erroneous CBs to be consecutive, and of the necessary minimum number of correctly received CBs scalar threshold considering all erroneous CBs to be non-consecutive;
a compression of the necessary minimum number of correctly received CBs threshold as the tuple of two to a singular scalar of a necessary minimum number of correctly received CBs threshold as nCB_{correct}^{necessary}=max(nCB−nCB_{err,max}^{consecutive}, nCB−nCB_{err,max}^{nonconsecutive});
or a combination thereof.

13. The UE of claim 1, wherein the at least one processor is configured to cause the UE to determine:
a first mapping of each CB error to network-coded packets errors aggregated towards a number of total network-coded packet errors; and
a second binary logic comparison to indicate whether the number of total network-coded packet errors is less than or equal to a number of packet errors tolerated by the NC configuration.

14. A method at a user equipment (UE), the method comprising:
receiving a multiplexing configuration of at least one network-coded logical channel and at least one non-network-coded logical channel multiplexed for transmissions scheduled over at least one transport block (TB);
receiving a network coding (NC) configuration corresponding to each network-coded logical channel of the at least one network-coded logical channel corresponding to each TB of the at least one TB;
determining, for each network-coded logical channel of the at least one network-coded logical channel corresponding to each TB of the at least one TB, a code block (CB) threshold based at least on the NC configuration and the multiplexing configuration;
configuring, for each TB of the at least one TB, a NC-aware and multiplexing-aware hybrid automatic repeat request (HARQ) process with the CB threshold and the multiplexing configuration; and
using the CB threshold and the multiplexing configuration to determine a NC-aware and multiplexing aware HARQ feedback report for each TB of the at least one TB.

15. A base station, comprising:
at least one memory; and
at least one processor coupled with the at least one memory and configured to cause the base station to:
determine a multiplexing configuration of at least one network-coded logical channel and at least one non-network-coded logical channel multiplexed for transmissions scheduled over at least one transport block (TB);
determine a network coding (NC) configuration corresponding to each network-coded logical channel of the at least one network-coded logical channel corresponding to each TB of the at least one TB;
determine, for each network-coded logical channel of the at least one network-coded logical channel corresponding to each TB of the at least one TB, a code block (CB) threshold based at least on the NC configuration and the multiplexing configuration;
transmit the multiplexing configuration, the NC configuration, the CB threshold, or some combination thereof to a receiver device for NC-aware and multiplexing-aware hybrid automatic repeat request (HARQ) feedback for each TB of the at least one TB; and
receive the NC-aware and multiplexing-aware HARQ feedback from the receiver device for each TB of the at least one TB, wherein the processor applies the NC-aware and multiplexing-aware HARQ feedback to determine necessary TB retransmissions.

16. A processor for wireless communication, comprising:
at least one controller coupled with at least one memory and configured to cause the processor to:
receive a multiplexing configuration of at least one network-coded logical channel and at least one non-network-coded logical channel multiplexed for transmissions scheduled over at least one transport block (TB);
receive a network coding (NC) configuration corresponding to each network-coded logical channel of the at least one network-coded logical channel corresponding to each TB of the at least one TB;
determine, for each network-coded logical channel of the at least one network-coded logical channel corresponding to each TB of the at least one TB, a code block (CB) threshold based at least on the NC configuration and the multiplexing configuration;
configure, for each TB of the at least one TB, a NC-aware and multiplexing-aware hybrid automatic repeat request (HARQ) process with the CB threshold and the multiplexing configuration; and
use the CB threshold and the multiplexing configuration to determine a NC-aware and multiplexing-aware HARQ feedback report for each TB of the at least one TB.

17. The processor claim 16, wherein a non-network-coded logical channel of the at least one non-network-coded logical channel is represented by a medium access control (MAC) control element (CE) (MAC CE).

18. The processor claim 16, wherein the NC configuration comprises:
a type of NC codebook;
a size of an NC packet;
a size of an NC symbol;
a number of systematic network-coded information carrying packets;
a number of systematic network-coded information carrying symbols;
a number of network-coded repair packets;
a number of network-coded repair symbols;
a total number of network-coded packets;
a total number of network-coded symbols;
a maximum size of a network-coded transmission;
a redundancy level of the NC;
a number of network-coded packets in the at least one network-coded logical channel multiplexed within each TB of the at least one TB;
a number of network-coded symbols in the at least one network-coded logical channel multiplexed within each TB of the at least one TB;
or a combination thereof.

19. The processor claim 16, wherein the NC configuration is signaled by:
a semi-static radio resource control (RRC) signaling indication;
a dynamic signaling indication of a downlink control information (DCI) scheduling at least one physical downlink shared channel (PDSCH) data traffic instance;
a dynamic signaling indication of a DCI scheduling of at least one group of PDSCH data traffic instances;
a dynamic MAC CE indication;
or a combination thereof.

20. The processor claim 16, wherein the multiplexing configuration encodes as a bit field for each of the at least one network-coded logical channel and the least one non-network-coded logical channel multiplexed:
a start position indication;
a stop position indication;
a length descriptor of multiplexed logical channel content;
a logical channel identifier (LCID);
or a combination thereof.
